(19) United States
(12) Patent Application Publication
(10) Pub. No.: US 2026/0088871 A1
(43) Pub. Date: Mar. 26, 2026

(54) PRECODING MATRIX INDICATORS FOR DISTINCT FREQUENCY FULL DUPLEX

(71) Applicant: QUALCOMM Incorporated, San Diego, CA (US)

(72) Inventors: Abdelrahman Mohamed Ahmed Mohamed Ibrahim, San Diego, CA (US); Muhammad Sayed Khairy Abdelghaffar, San Jose, CA (US); Yu Zhang, San Diego, CA (US); Chenxi Hao, Beijing (CN); Ahmed Attia Abotabl, San Diego, CA (US); Lei Xiao, San Jose, CA (US); Faris Rassam, El Cajon, CA (US)

(21) Appl. No.: 19/109,438

(22) PCT Filed: Oct. 28, 2022
(86) PCT No.: PCT/CN2022/128218

§ 371 Date: Mar. 6, 2025

(51) Int. Cl. H04B 7/06; H04L 5/14

(52) U.S. Cl. CPC H04B 7/0626; H04B 7/0639; H04B 7/0658; H04L 5/14

(57) ABSTRACT

This disclosure discloses systems, methods, and devices for wireless communication that support distinct frequency full duplex (DFFD) subband based basis precoding matrix indicators (PMIs) comprising frequency domain compression based at least in part on a correspondence between downlink subbands for a DFFD wireless signal and channel state indicator (CSI) subbands of a CSI subband configuration for the DFFD wireless signal communication. A number of subbands for PMI calculation may be determined based at least in part on CSI subbands having overlap with respect to one or more downlink subbands and frequency domain compression basis determined based at least in part on the determined number of subbands for PMI. Frequency domain basis computation and/or PMI reporting may be provided together or separately with respect to each downlink subband for DFFD wireless signal communication. Other aspects and features are also claimed and described.

### TECHNICAL FIELD

Aspects of the present disclosure relate generally to wireless communication systems, and more particularly, to precoding matrix indicators (PMIs) for distinct frequency full duplex (DFFD) wireless signal communication, such as subband full duplex (SBFD) wireless signal communication. Some features may enable and provide improved communications, including optimized frequency domain compression of PMI for DFFD wireless signal communication facilitating reduced channel state information (CSI) overhead.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Full duplex modes, in which one or more wireless communications devices simultaneously transmit and receive in the same slot, may be utilized for facilitating various efficiencies in wireless communications, such as enhanced capacity, resource utilization, or spectrum efficiency. Full duplex mode implementations, however, often introduce issues with respect to various forms of interference. For example, a wireless communications device operating in a full duplex mode may experience self-interference (SI) from its signal transmission to its signal reception (e.g., directly received instances of the transmitted signal and/or indirectly received reflected instances of the transmitted signal). Additionally, a wireless communications device receiving signals according to a full duplex mode implementation may experience crosslink interference (CLI) associated with the full duplex communication clutter (e.g., signals transmitted by one or more other devices operating in the full duplex mode). Full duplex communications may thus benefit from channel state information (CSI) reporting used in realizing desired efficiencies in any particular implementation.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication may include determining a first precoding matrix subband parameter for a precoding matrix selected by the UE to be used in communication of a distinct frequency full duplex (DFFD) wireless signal via one or more spatial beams. The first precoding matrix subband parameter may be determined based, at least in part, on a correspondence between one or more downlink subbands for the DFFD wireless signal and channel state information (CSI) subbands of a CSI subband configuration for the DFFD wireless signal. The method may also include determining a first frequency domain compression basis parameter for frequency domain compression of coefficients of the spatial beams in the precoding matrix. The first frequency domain compression basis parameter may be determined based, at least in part, on the first precoding matrix subband parameter. Further, the method may include transmitting a compressed representation of the coefficients as a precoding matrix indicator (PMI). The compressed representation of the coefficients may comprise a frequency domain compression of the coefficients in accordance with the first frequency domain compression basis parameter.

In an additional aspect of the disclosure, an apparatus includes at least one processor and a memory coupled to the at least one processor. The at least one processor may be configured to determine a first precoding matrix subband parameter for a precoding matrix selected by the UE to be used in communication of a DFFD wireless signal via one or more spatial beams. The first precoding matrix subband parameter may be determined based, at least in part, on a correspondence between one or more downlink subbands for the DFFD wireless signal and CSI subbands of a CSI subband configuration for the DFFD wireless signal. The at least one processor may also be configured to determine a first frequency domain compression basis parameter for frequency domain compression of coefficients of the spatial beams in the precoding matrix. The first frequency domain compression basis parameter may be determined based, at least in part, on the first precoding matrix subband parameter. Further, the at least one processor may be configured to initiate transmission of a compressed representation of the coefficients as a PMI. The compressed representation of the coefficients may comprise a frequency domain compression of the coefficients in accordance with the first frequency domain compression basis parameter.

In an additional aspect of the disclosure, an apparatus may include means for determining a first precoding matrix subband parameter for a precoding matrix selected by the UE to be used in communication of a DFFD wireless signal via one or more spatial beams. The first precoding matrix subband parameter may be determined based, at least in part, on a correspondence between one or more downlink subbands for the DFFD wireless signal and CSI subbands of a CSI subband configuration for the DFFD wireless signal. The apparatus may also include means for determining a first frequency domain compression basis parameter for frequency domain compression of coefficients of the spatial beams in the precoding matrix. The first frequency domain compression basis parameter may be determined based, at least in part, on the first precoding matrix subband parameter. Further, the apparatus may include means for transmitting a compressed representation of the coefficients as a PMI. The compressed representation of the coefficients may comprise a frequency domain compression of the coefficients in accordance with the first frequency domain compression basis parameter.

In an additional aspect of the disclosure, a non-transitory computer-readable medium stores instructions that, when executed by a processor, cause the processor to perform operations. The operations may include determining a first precoding matrix subband parameter for a precoding matrix selected by the UE to be used in communication of a DFFD wireless signal via one or more spatial beams. The first precoding matrix subband parameter may be determined based, at least in part, on a correspondence between one or more downlink subbands for the DFFD wireless signal and CSI subbands of a CSI subband configuration for the DFFD wireless signal. The operations may also include determining a first frequency domain compression basis parameter for frequency domain compression of coefficients of the spatial beams in the precoding matrix. The first frequency domain compression basis parameter may be determined based, at least in part, on the first precoding matrix subband parameter. Further, the operations may include transmitting a compressed representation of the coefficients as a PMI. The compressed representation of the coefficients may comprise a frequency domain compression of the coefficients in accordance with the first frequency domain compression basis parameter.

In one aspect of the disclosure, a method for wireless communication may include transmitting a CSI subband configuration with respect to DFFD wireless signal communication. The method may also include receiving a PMI comprising a compressed representation of coefficients of spatial beams of a precoding matrix configured for communication of the DFFD wireless signal via one or more spatial beams. The compressed representation of the coefficients may comprise a frequency domain compression of the coefficients in accordance with a first frequency domain compression basis parameter determined for the precoding matrix based, at least in part, on a first precoding matrix subband parameter. The first precoding matrix subband parameter may be based, at least in part, on a correspondence between one or more downlink subbands for the DFFD wireless signal and CSI subbands of the CSI subband configuration. Further the method may include determining whether to initiate transmission of the DFFD wireless signal implementing the precoding matrix of the PMI or another precoding matrix configuration.

In an additional aspect of the disclosure, an apparatus may include at least one processor and a memory coupled to the at least one processor. The at least one processor is configured to initiate transmission of a CSI subband configuration with respect to DFFD wireless signal communication. The at least one processor may also be configured to initiate reception of a PMI comprising a compressed representation of coefficients of spatial beams of a precoding matrix configured for communication of the DFFD wireless signal via one or more spatial beams. The compressed representation of the coefficients may comprise a frequency domain compression of the coefficients in accordance with a first frequency domain compression basis parameter determined for the precoding matrix based, at least in part, on a first precoding matrix subband parameter. The first precoding matrix subband parameter may be based, at least in part, on a correspondence between one or more downlink subbands for the DFFD wireless signal and CSI subbands of the CSI subband configuration. Further, the at least one processor may be configured to determine whether to initiate transmission of the DFFD wireless signal implementing the precoding matrix of the PMI or another precoding matrix configuration.

In an additional aspect of the disclosure, an apparatus may include means for transmitting a CSI subband configuration with respect to DFFD wireless signal communication. The apparatus may also include means for receiving a PMI comprising a compressed representation of coefficients of spatial beams of a precoding matrix configured for communication of the DFFD wireless signal via one or more spatial beams. The compressed representation of the coefficients may comprise a frequency domain compression of the coefficients in accordance with a first frequency domain compression basis parameter determined for the precoding matrix based, at least in part, on a first precoding matrix subband parameter. The first precoding matrix subband parameter may be based, at least in part, on a correspondence between one or more downlink subbands for the DFFD wireless signal and CSI subbands of the CSI subband configuration. Further the apparatus may include means for determining whether to initiate transmission of the DFFD wireless signal implementing the precoding matrix of the PMI or another precoding matrix configuration.

In an additional aspect of the disclosure, a non-transitory computer-readable medium stores instructions that, when executed by a processor, cause the processor to perform operations. The operations may include transmitting a CSI subband configuration with respect to DFFD wireless signal communication. The operations may also include receiving a PMI comprising a compressed representation of coefficients of spatial beams of a precoding matrix configured for communication of the DFFD wireless signal via one or more spatial beams. The compressed representation of the coefficients may comprise a frequency domain compression of the coefficients in accordance with a first frequency domain compression basis parameter determined for the precoding matrix based, at least in part, on a first precoding matrix subband parameter. The first precoding matrix subband parameter may be based, at least in part, on a correspondence between one or more downlink subbands for the DFFD wireless signal and CSI subbands of the CSI subband configuration. Further the operations may include determining whether to initiate transmission of the DFFD wireless signal implementing the precoding matrix of the PMI or another precoding matrix configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example disaggregated base station architecture according to one or more aspects.

FIGS. 4A-4C are configurations of full duplex modes in a single bandwidth part (BWP) or component carrier (CC) as may be utilized by wireless communications devices.

FIGS. 5A and 5B are an example of a full duplex wireless communication mode in which a base station is operating in a full duplex mode while UEs are each operating in a half duplex mode according to one or more aspects.

FIGS. 6A and 6B are an example of a full duplex wireless communication mode in which a base station and UE are each operating in a full duplex mode while another UE is operating in a half duplex mode according to one or more aspects.

FIGS. 7A and 7B are an example of a full duplex wireless communication mode in which base stations 105d and 105e are implementing a multiple transmission and reception architecture for a full duplex mode, a UE is operating in a full duplex mode, and another UE is operating in a half duplex mode according to one or more aspects.

FIG. 8 is a procedure for implementing eType-II codebook according to one or more aspects.

FIG. 9 is a block diagram illustrating an example wireless communication system that supports distinct frequency full duplex (DFFD) subband based basis precoding matrix indicators (PMIs) according to one or more aspects.

FIGS. 10A and 10B are example CSI subband configurations and DFFD subband allocations according to one or more aspects.

FIG. 11 is an example in which a frequency domain basis parameter is selected out of a corresponding precoding matrix subband parameter for each downlink subband according to one or more aspects.

FIG. 12 is an example of coefficients for PMI subbands corresponding to one or more CSI subbands fully overlapping an uplink subband and/or guard band set to dummy CSI according to one or more aspects.

FIG. 13 is a flow diagram illustrating an example process implemented by a UE that supports DFFD subband based basis precoding matrix indicators PMIs according to one or more aspects.

FIG. 14 is a block diagram of an example UE that supports DFFD subband based basis precoding matrix indicators PMIs according to one or more aspects.

FIG. 15 is a flow diagram illustrating an example process implemented by a base station that supports DFFD subband based basis precoding matrix indicators PMIs according to one or more aspects.

FIG. 16 is a block diagram of an example base station that supports DFFD subband based basis precoding matrix indicators PMIs according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support precoding matrix indicators (PMIs) for distinct frequency full duplex (DFFD) wireless signal communication. DFFD wireless signal communication according to the present disclosure is a full duplex communication configuration having one or more downlink frequency band which is fully or partially non-overlapping the uplink frequency band(s) in the frequency domain, such as subband full duplex (SBFD) signals, partially overlapping in-band full duplex (IBFD) signals, etc. For example, a PMI according to aspects of the disclosure (referred to herein as DFFD subband based basis PMI) may comprise frequency domain compression based at least in part on a correspondence between downlink subbands for a DFFD wireless signal and channel state information (CSI) subbands of a CSI subband configuration for the DFFD wireless signal communication. Frequency domain compression provided according to some aspects of the disclosure may determine a number of subbands for PMI calculation based at least in part on CSI subbands having overlap (e.g., fully overlapping or partially overlapping) with respect to one or more downlink subbands and frequency domain compression basis determined based at least in part on the determined number of subbands for PMI. Operation according to aspects of the disclosure may, for example, provide calculating frequency domain basis and/or PMI reporting together or separately with respect to each downlink subband for DFFD wireless signal communication. In accordance with some examples, PMI reporting granularity may be determined based at least in part on whether and, in some cases, to what extent (e.g., number of resource blocks (RBs)) one or more downlink subbands partially overlap a CSI subband.

Particular implementations of the subject matter described in this disclosure may be implemented to realize one or more of the following potential advantages or benefits. In some aspects, the present disclosure provides techniques for PMI having frequency domain compression optimized or otherwise configured for DFFD wireless signal communication, such as may be utilized in implementations having reduced CSI overhead.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave”band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mm Wave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

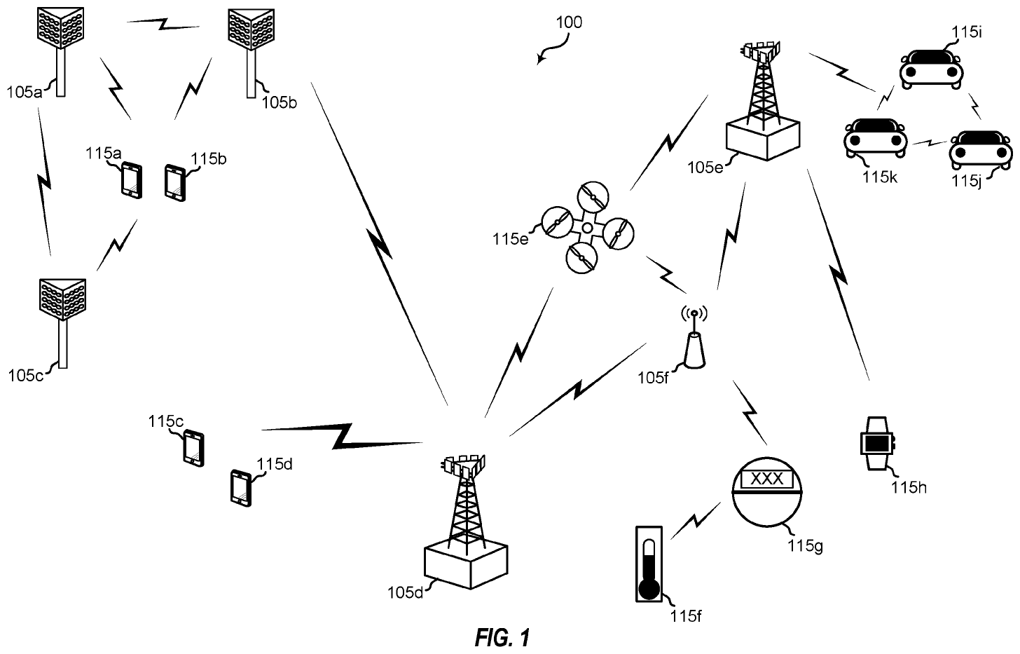

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IOT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (COMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

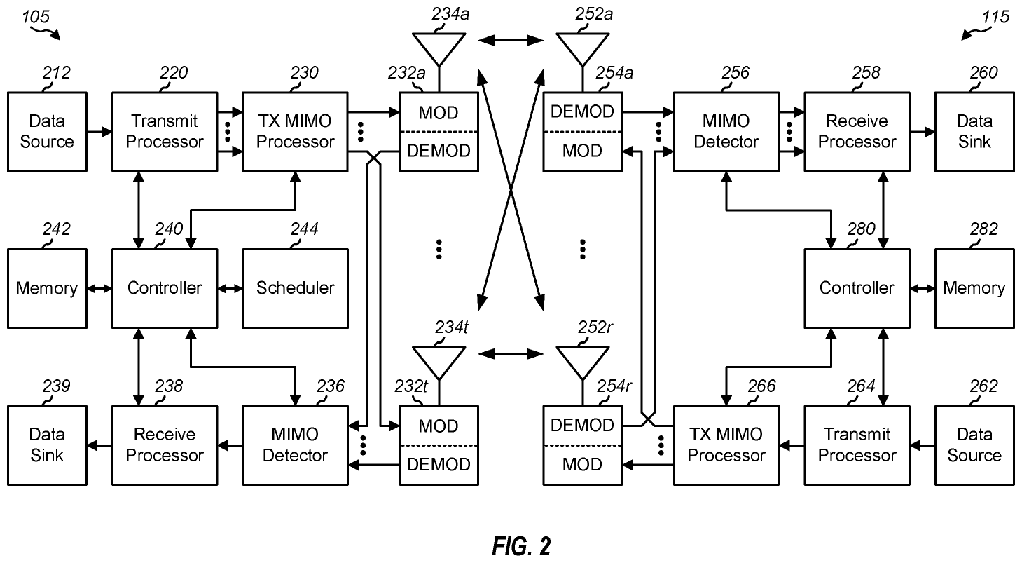

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

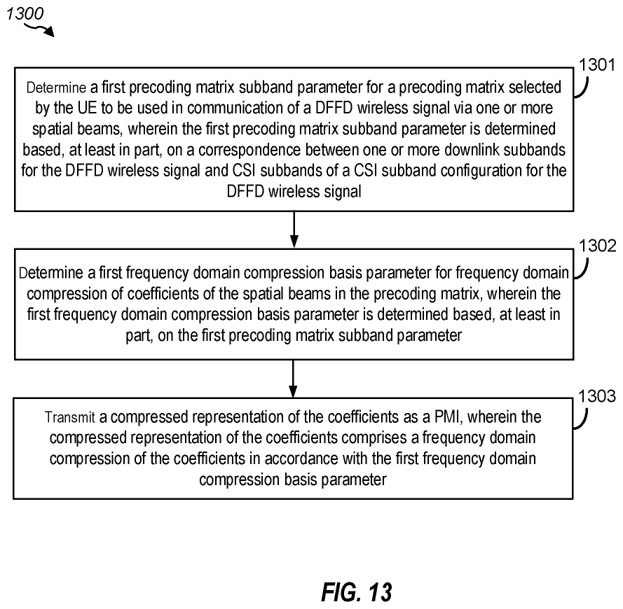

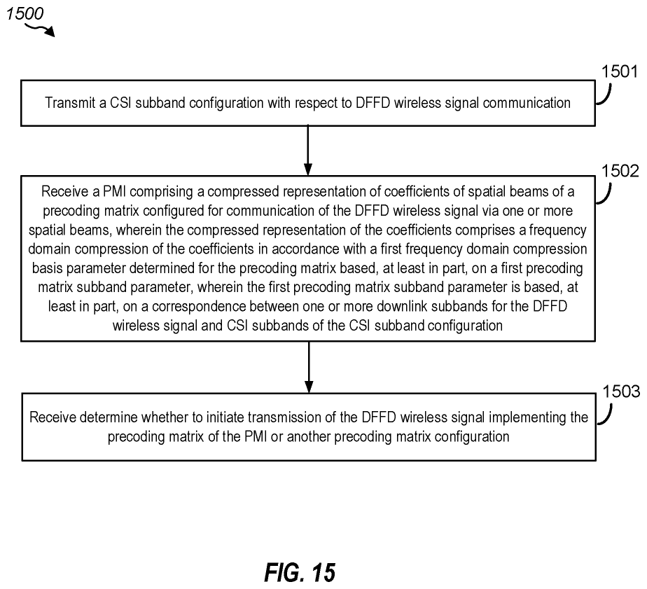

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 13 and 15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

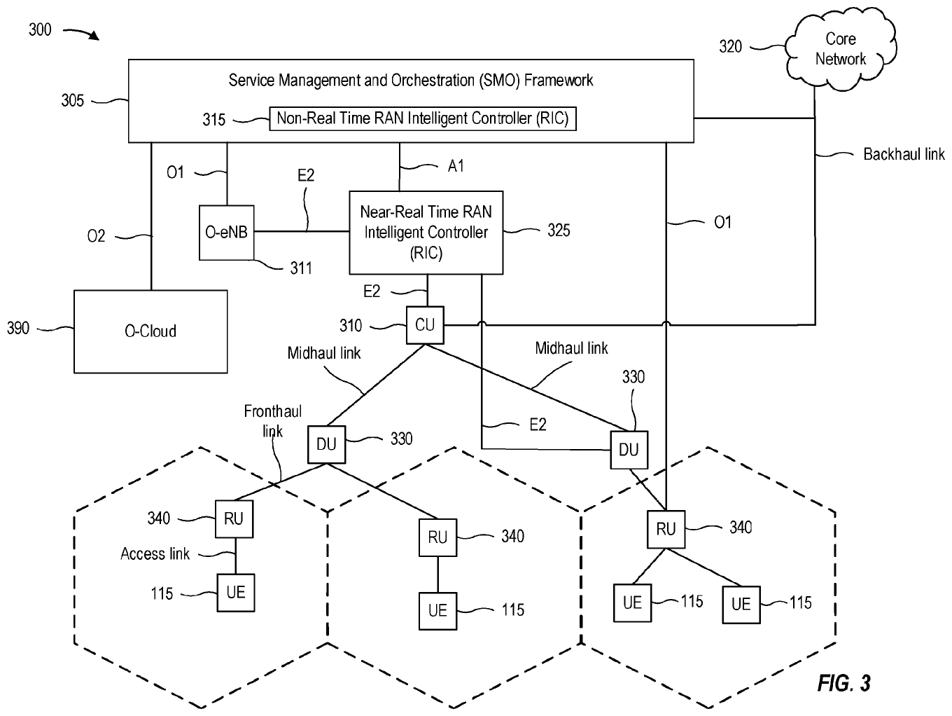

FIG. 3 shows a diagram illustrating an example disaggregated base station architecture 300, such as may be implemented by one or more of base stations 105. The disaggregated base station architecture 300 may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more RF access links. In some implementations, the UE 115 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

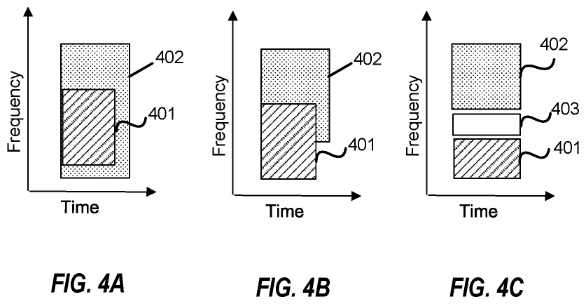

Various wireless communications devices (e.g., one or more of UEs 115 and/or base station 105) of wireless network 100 may operate in half duplex mode or full duplex mode. FIGS. 4A-4C illustrate configurations of full duplex modes in a single bandwidth part (BWP) or component carrier (CC) as may be utilized by wireless communications devices of wireless network 100. It should be appreciated that FIGS. 4A-4C present examples with respect to duplex mode configurations that may be utilized and are not intended to be limiting with respect to the particular configurations that may be utilized by wireless communications devices that may implement full duplex operation according to concepts of the disclosure.

As can be seen in FIGS. 4A-4C, uplink resources 401 of the full duplex modes overlap downlink resources 402 in time. That is, in these examples, a wireless communications devices implementing a full duplex mode with respect to wireless communications transmits and receives at the same time. A wireless communications device may implement a full duplex mode for communication with one or more other wireless communications devices also operating in the full duplex mode (e.g., each such wireless communications device transmitting and receiving at the same time). Additionally or alternatively, a wireless communications device may implement a full duplex mode for communication with one or more wireless communications devices operating in a half duplex mode (e.g., although the wireless communications device operating in the full duplex mode may transmit and receive at the same time, wireless communications devices operating in the half duplex mode may either transmit or receive at any particular time, such as where one wireless communications device operating in the half duplex mode receives downlink signals from the wireless communications device operating in the full duplex mode simultaneously with another wireless communications device operating in the half duplex mode transmits uplink signals to the wireless communications device operating in the full duplex mode).

Various configurations may be utilized with respect to a full duplex mode, as represented by the examples of FIGS. 4A-4C. For example, FIGS. 4A and 4B show examples of IBFD, wherein uplink resources 401 of the full duplex modes overlap downlink resources 402 in time and frequency. That is the uplink signals and downlink signals at least partially share the same time and frequency resource (e.g., full or partial overlap of the uplink and downlink signals in the time and frequency domains). Although some configurations of IBFD may provide for the downlink signals fully overlapping the uplink signals in the frequency domain, the examples illustrated in FIGS. 4A and 4B provide configurations in which downlink resources 402 are at least partially non-overlapping uplink resources 401 in the frequency domain. Such IBFD configurations, in which the resources of one or more downlink signals is fully or partially non-overlapping with respect to resources of corresponding uplink signals, are examples of DFFD.

In another configuration of a full duplex mode, FIG. 4C shows an example of SBFD, wherein uplink resources 401 of the full duplex mode overlaps downlink resources 402 in time, but not in frequency. That is the uplink signals and downlink signals at least partially share the same time resource (e.g., full or partial overlap of the uplink and downlink signals in the time domain), but do not share the same frequency resource. In the example illustrated in FIG. 4C, uplink resources 401 and downlink resources 402 are separated in the frequency domain by guard band resources 403 (e.g., a relatively narrow amount of frequency spectrum separating the frequency band occupied by the uplink and downlink signals). The example illustrated in FIG. 4C provides a configuration in which downlink resources 402 are fully non-overlapping uplink resources 401 in the frequency domain. Such SBFD configurations, in which the resources of one or more downlink signals is fully non-overlapping with respect to resources of corresponding uplink signals, are further examples of DFFD.

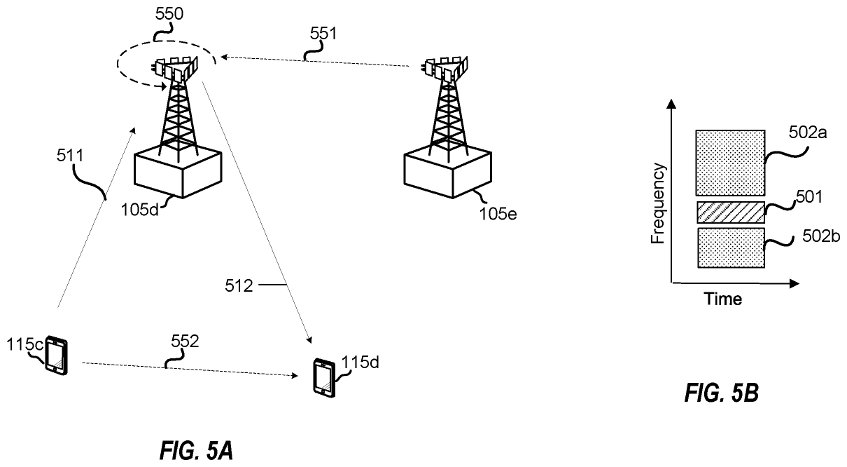

FIGS. 5A-7B illustrate examples in which full duplex wireless communications modes are implemented by at least one wireless device of particular communication links. It should be appreciated that FIGS. 5A, 6A, and 7A represent a portion of wireless network 100 selected for illustrating full duplex communications and that the particular base stations and UEs depicted are not intended to be limiting with respect to the various wireless communication stations that may operate in a full duplex communication mode or that may implement full duplex slot formats according to concepts of the disclosure.

In the example of FIG. 5A, base station 105d is operating in a full duplex mode while UEs 115c and 115d are each operating in a half duplex mode. The full duplex mode may, for example, utilize a full duplex configuration in which downlink signal 512 is fully or partially non-overlapping in the frequency domain with respect to uplink signal 511. For example, a SBFD configuration as illustrated in FIG. 5B may be utilized such that base station 105d may receive uplink signal 511 via uplink resources 501 and may transmit downlink signal 512 via downlink resources 502a and 502b, wherein downlink resources 502a and 502b are fully non-overlapping with respect to uplink resources 501 in the frequency domain (e.g., a DFFD implementation). Correspondingly, UE 115d may transmit uplink signal 111 via uplink resources 501 and UE 115c may receive downlink signal 512 via downlink resources 502a and 502b. As illustrated in this example, base station 105d may experience self-interference (SI) 550 associated with transmission of downlink signal 512 when attempting to receive uplink signal 511, in addition to external interference (e.g., crosslink interference (CLI) 551 from base station 105e). Likewise, UE 115d may experience CLI 552 from UE 115c when attempting to receive downlink signal 512.

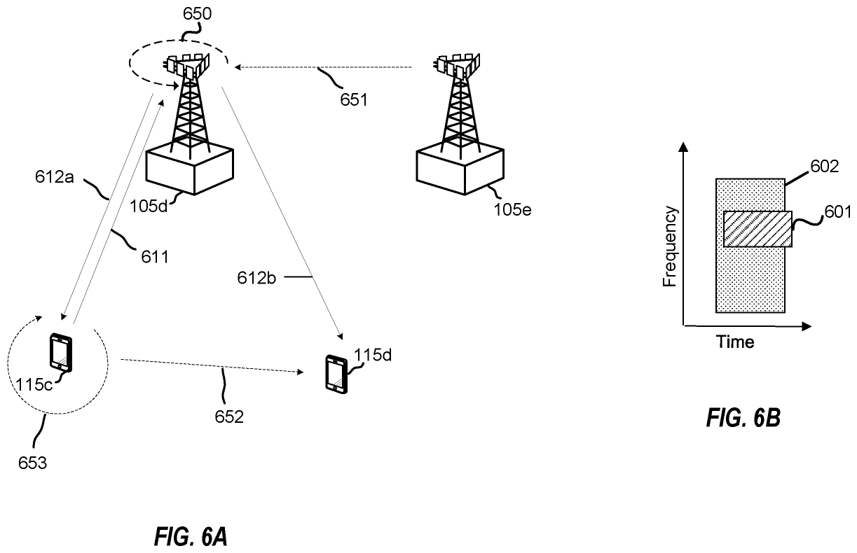

In the example of FIG. 6A, base station 105d and UE 115c are each operating in a full duplex mode while UE 115d is operating in a half duplex mode. As in the foregoing example, the full duplex mode may utilize a full duplex configuration in which downlink signal 612a and/or 612b are fully or partially non-overlapping in the frequency domain with respect to uplink signal 611. For example, an IBFD configuration as illustrated in FIG. 6B may be utilized such that base station 105d may receive uplink signal 611 via uplink resources 601 and may transmit downlink signals 612a and 612b via downlink resources 602, wherein downlink resources 602 are partially non-overlapping with respect to uplink resources 601 in the frequency domain (e.g., a DFFD implementation). Correspondingly, UE 115c may transmit uplink signal 611 via uplink resources 601 and may receive downlink signal 612a via some or all of downlink resources 602. UE 115d may likewise receive downlink signal 612b via some or all of downlink resources 602. As illustrated in this example, base station 105d may experience SI 650 associated with transmission of downlink signals 612a and 612b when attempting to receive uplink signal 611, in addition to external interference (e.g., CLI 651 from base station 105e). Likewise, UE 115d may experience CLI 652 from UE 115c when attempting to receive downlink signal 612b and UE 115c may experience SI 653 associated with transmission of uplink signal 611 when attempting to receive downlink signal 612a.

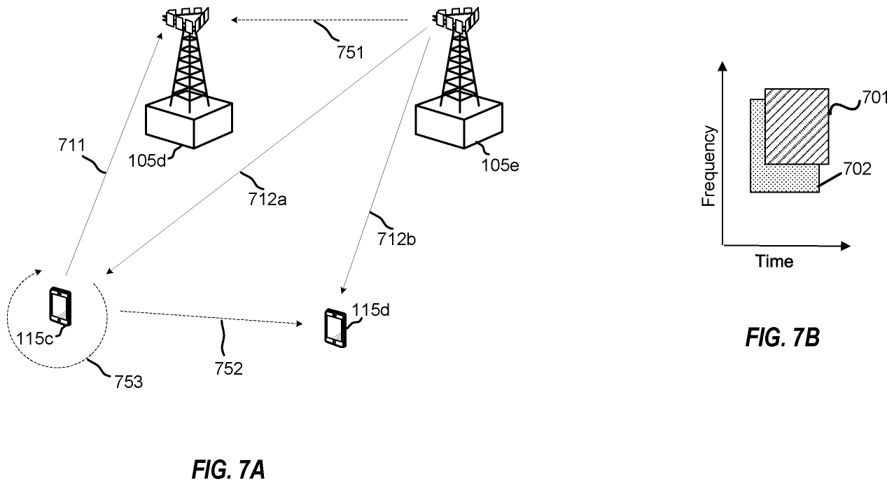

In the example of FIG. 7A, base stations 105d and 105e are implementing a multiple transmission and reception (multi-TRP) architecture, such as may implement coordinated scheduling, coordinated beamforming and dynamic point selection/dynamic point blanking. Accordingly, in this example, base stations 105d and 105e in aggregation and UE 115c are operating in a full duplex mode while UE 115d is operating in a half duplex mode. As in the foregoing examples, the full duplex mode may utilize a full duplex configuration in which downlink signal 712a and/or 712b are fully or partially non-overlapping in the frequency domain with respect to uplink signal 711. For example, an IBFD configuration as illustrated in FIG. 7B may be utilized such that base station 105d may receive uplink signal 711 via uplink resources 701 and base station 105e may transmit downlink signals 712a and 712b via downlink resources 702, wherein downlink resources 702 are partially non-overlapping with respect to uplink resources 701 in the frequency domain (e.g., a DFFD implementation). Correspondingly, UE 115c may transmit uplink signal 711 via uplink resources 701 and may receive downlink signal 712a via some or all of downlink resources 702. UE 115d may likewise receive downlink signal 712b via some or all of downlink resources 702. As illustrated in this example, base station 105d may experience CLI 751 associated with transmission of downlink signals 712a and 712b when attempting to receive uplink signal 711. Likewise, UE 115d may experience CLI 752 from UE 115c when attempting to receive downlink signal 712b and UE 115c may experience SI 753 associated with transmission of uplink signal 711 when attempting to receive downlink signal 712a.

It should be appreciated that the full duplex wireless communications modes and their particular configurations in FIGS. 5A-7B are non-limiting examples of implementations in which PMIs for DFFD wireless signal communication may be provided according to concepts of the present disclosure. Implementations in accordance with aspects herein may, for example, utilize more or fewer downlink resources and/or bands, uplink resources and/or bands, guard band resources/bands, etc. For example, one or more guard bands may be provided between uplink resources 501 and either or both of downlink resources 502a and 502b of FIG. 5B. Additionally or alternatively, implementations in accordance with aspects herein may utilize different overlap/non-overlap of downlink resources/bands and uplink resources/bands, different frequency domain and/or time domain relative positioning between downlink resources/bands and uplink resources/band, etc.

As can be seen in the full duplex wireless communications examples of FIGS. 5A, 6A, and 7A, full duplex mode implementations can introduce issues with respect to various forms of interference, such as the instances of SI and CLI described above. Accordingly, CSI measurements and feedback may be implemented for use in adapting the wireless communications for interference avoidance and/or mitigation. For example, communication devices (e.g., UEs and/or base stations) may operate to make CSI measurements in one or more frequency bands (e.g., measuring receive aspects with respect to a reference signal (RS) transmitted by a base station) and provide feedback to one or more communication devices in communication therewith, such as for implementing precoding, beamforming, resource assignment, etc. CSI feedback information may, for example, comprise information regarding a set of precoders (e.g., matrix having complex values to control the amplitudes and phases of signals sent from the various transmit antennas to focus energy toward the intended receiver) to be implemented in a transmission chain of a communication device for avoiding or mitigating interference.

5G NR provides for the use of codebooks with respect to precoders. For example, 5G NR supports two types of codebooks for precoders: Type-I codebook and Type-II codebook. Type-I codebook provides a plurality of predefined matrices which may be selected by a CSI report. In contrast, Type-II codebook is not based on predefined matrices, but instead provide a formula defining the precoding matrix. For example, coefficients (e.g., wideband and subband phase and amplitude) of spatial beams for wireless signal transmission may be provided in a CSI report.

For Type-I codebook and Type-II codebook, the number of CSI subbands (also referred to by the parameter “N3”) for the CSI report is equal to the number of channel quality indicator (CQI) subbands (e.g., the PMI subbands correspond to the number of CSI subbands and provides CSI subband granularity). The determination of the CSI subbands for SBFD slots follows these same rules, such that CQI subbands corresponding to uplink subbands and/or guard bands are included in the PMI subband determination.

In operation according to 5G NR Release 15, Type-II CSI uses a linear combination of discrete Fourier transform (DFT) beams to capture spatial domain sparsity. The Type-II CSI coefficients are reported per beam per PMI subband (N3 subbands) in a CSI report. Use of the foregoing Type-II codebook implementation results in high CSI overhead in situations where there is a large number of subbands and/or beams.

5G NR Release 16 provides for enhanced Type-II codebook (eType-II) utilizing frequency domain compression, selecting M frequency domain basis out of N3 basis for frequency domain compression with DFT, in an attempt to reduce CSI overhead. For eType-II codebook, the number of CSI subbands, N3, is either equal to the number of CQI subbands (i.e., same as Type-I codebook and Type-II codebook above) or the number of CSI subbands is approximately twice the number of CQI subbands (e.g., the PMI subbands are provided twice the CSI subband granularity). The way the CSI subbands are defined they are not required to align with the bandwidth part (BWP) boundaries of the frequency allocations for wireless communications, and therefor there may be an outer edge at which a CSI subband does not overlap a wireless communication subband. The additional granularity with respect to the PMI subbands is provided to accommodate more accurate PMI feedback (e.g., the number of CSI subbands, N3, is equal to twice the number of CQI subbands less a number (i.e., 1 or 2) of non-aligned outer edges).

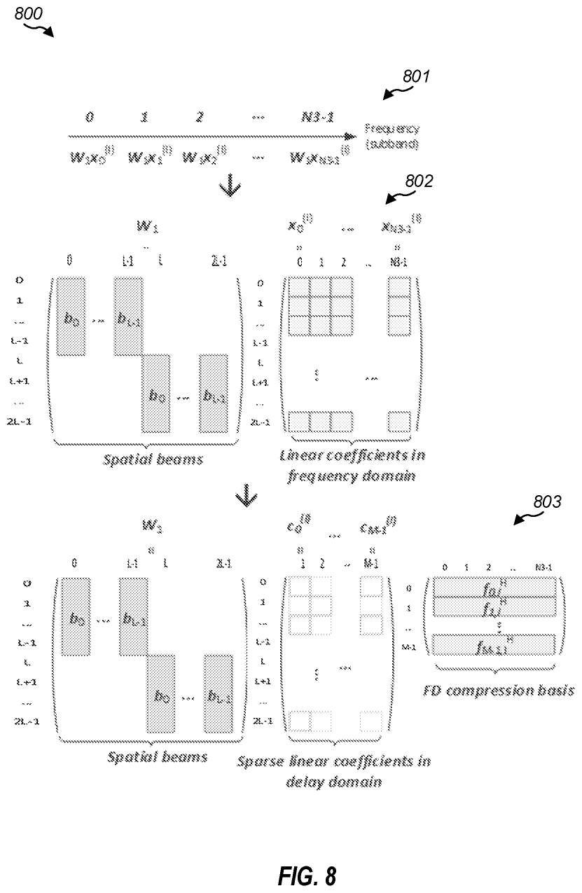

In operation according to 5G NR Release 16, eType-II CSI uses frequency domain compression of the linear combination coefficients via DFT bases. Accordingly, 5G NR Release 16 eType-II CSI report spatial beams, coefficients (in delay domain), and frequency domain compression basis. The procedure for implementing eType-II codebook according to 5G NR Release 16 is shown as flow 800 in FIG. 8. The procedure provides for a UE to calculate the precoder on each PMI subband (N3 subbands) as a linear combination of spatial beams, as shown at process 801. Thereafter, the procedure provides for the UE to aggregate coefficients on each PMI subband per layer, as shown at process 802. This provides Type-II CSI coefficients according to the technique of 5G NR Release 15. The procedure, however, further provides for the UE to implement frequency domain compression of coefficients via DFT basis to provide sparse linear coefficients in delay domain instead of linear coefficients in frequency domain, as shown at process 803. In operation according to 5G NR Release 16, M CSI subbands (e.g., the frequency domain compression basis is M) of the N3 basis having coefficients with the highest correlation are selected as the basis for frequency domain compression with DFT. The sparse linear coefficients and the frequency domain compression basis used in their compression are included in a CSI report as PMI.

The above described eType-II codebook procedure may result in decreased CSI overhead, as compared to Type-II codebook implementations, in light of the compression. Nevertheless, the procedure is not optimized for various communication modes, such as full duplex modes having non-contiguous subbands, non-overlapping downlink and uplink subbands, etc. (e.g., SBFD and/or some other DFFD configurations), and thus does not realize all potential CSI overhead reduction with respect to these communication modes.

A SBFD slot, for example, may be configured to provide an uplink subband and associated guard bands in a frequency band between downlink subbands (e.g., uplink resources 501 and downlink resources 502a and 502b of FIG. 5B). Accordingly, one or more CSI subbands may be overlapping (e.g., fully or partially) an uplink subband and/or guard band. Because there is no downlink subband corresponding to the uplink subbands and guard bands in this SBFD example, no CSI-RS may be transmitted in correspondence with these subbands (e.g., CSI subbands fully overlapping uplink subbands and/or guard bands may be considered dummy CSI subbands). In a case where the PMI includes PMI subbands for these CSI subbands, the frequency domain compression provided by the eType-II codebook process is less efficient (e.g., the zero coefficients results in redundant computations).

5G NR Release 16 supports selection of non-contiguous CSI subbands for CSI reporting. For example, CSI subbands may be selected in correspondence with a CSI subband configuration having non-contiguous subbands (e.g., a CSI configuration bitmap may indicate CSI subbands=1110011, where 1's represent CSI subbands for which CSI-RS is transmitted and 0's represent for which CSI-RS is not transmitted). The use of such non-contiguous subband configurations generally results in reduced effectiveness of the frequency domain compression. The CSI subbands with gap in the middle will have lower correlation (e.g., the second CSI subband will likely have low correlation when compared to seventh CSI subband) and hence selection of frequency domain basis for compression may not be optimal when done over all the subbands.

In operation according to aspects of the present disclosure, PMIs for DFFD wireless signal communication utilize frequency domain compression in which the frequency domain compression basis is configured to take into account the intersections of the CSI subbands and the downlink subbands for the DFFD wireless signal communication. PMI according to aspects of the disclosure may comprise frequency domain compression based at least in part on a correspondence between downlink subbands for a DFFD wireless signal and CSI subbands of a CSI subband configuration for the DFFD wireless signal communication. Frequency domain compression provided according to some aspects of the disclosure may determine a number of subbands for PMI calculation based at least in part on downlink subbands having overlap (e.g., fully overlapping or partially overlapping) with respect to one or more CSI subbands and utilizing frequency domain compression basis based at least in part on the determined number of subbands for PMI. Operation according to aspects of the disclosure may, for example, provide calculating frequency domain basis and/or PMI reporting together or separately with respect to each downlink subband for SBFD wireless signal communication. In accordance with some examples, PMI reporting granularity may be determined based at least in part on whether and, in some cases, to what extent (e.g., number of RBs) one or more downlink subbands partially overlap a CSI subband.

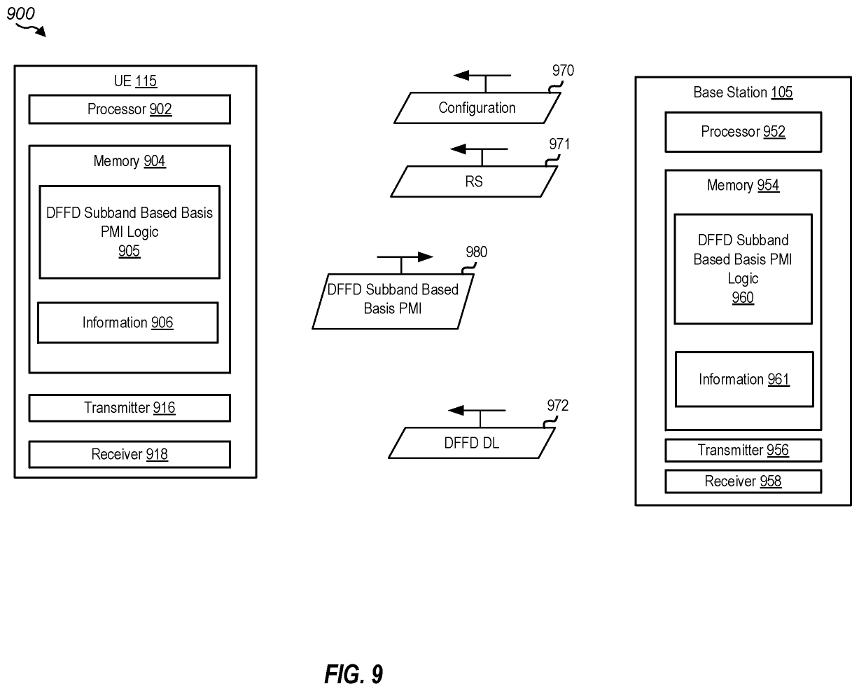

FIG. 9 is a block diagram of an example wireless communications system 900 that supports DFFD subband based basis PMI comprising frequency domain compression based at least in part on a correspondence between downlink subbands for a DFFD wireless signal and CSI subbands of a CSI subband configuration for the DFFD wireless signal communication according to one or more aspects of the present disclosure. In some examples, wireless communications system 900 may implement aspects of wireless network 100. Wireless communications system 900 includes UE 115 and base station 105. Although one UE 115 and one base station 105 are illustrated, in some other implementations, wireless communications system 900 may generally include multiple UEs 115, and may include more than one base station 105.

UE 115 may include a variety of components (such as structural, hardware components) used for carrying out one or more functions described herein. For example, these components may include one or more processors 902 (hereinafter referred to collectively as “processor 902”), one or more memory devices 904 (hereinafter referred to collectively as “memory 904”), one or more transmitters 916 (hereinafter referred to collectively as “transmitter 916”), and one or more receivers 918 (hereinafter referred to collectively as “receiver 918”). Processor 902 may be configured to execute instructions stored in memory 904 to perform the operations described herein. In some implementations, processor 902 includes or corresponds to one or more of receive processor 258, transmit processor 264, and controller 280, and memory 904 includes or corresponds to memory 282.

Memory 904 includes or is configured to store DFFD subband based basis PMI logic 905 and information 906. DFFD subband based basis PMI logic of examples may include various instructions, code, routines, procedures, etc. configured to perform operations and/or functions for providing PMI for DFFD wireless signal communication according concepts described herein. Information 906 of examples may include various parameters, values, data, databases, information, etc. (e.g., CSI measurement information, CSI subband configuration information, DFFD subband allocation information, coefficients of spatial beams for DFFD wireless signal transmission, parameters used in computing DFFD subband based basis PMI, DFFD subband based basis PMI, etc.) utilized by DFFD subband based basis PMI logic 905 and/or in association with operations and/or functions for providing PMI for DFFD wireless signal communication.

Transmitter 916 is configured to transmit reference signals, control information and data to one or more other devices, and receiver 918 is configured to receive references signals, synchronization signals, control information, and data from one or more other devices. For example, transmitter 916 may transmit signaling, control information and data to, and receiver 918 may receive signaling, control information and data from, base station 105. In some implementations, transmitter 916 and receiver 918 may be integrated in one or more transceivers. Additionally or alternatively, transmitter 916 or receiver 918 may include or correspond to one or more components of UE 115 described with reference to FIG. 2.

Base station 105 may include a variety of components (such as structural, hardware components) used for carrying out one or more functions described herein. For example, these components may include one or more processors 952 (hereinafter referred to collectively as “processor 952”), one or more memory devices 954 (hereinafter referred to collectively as “memory 954”), one or more transmitters 956 (hereinafter referred to collectively as “transmitter 956”), and one or more receivers 958 (hereinafter referred to collectively as “receiver 958”). Processor 952 may be configured to execute instructions stored in memory 954 to perform the operations described herein. In some implementations, processor 952 includes or corresponds to one or more of receive processor 238, transmit processor 220, and controller 240, and memory 954 includes or corresponds to memory 242.

Memory 954 includes or is configured to store DFFD subband based basis PMI logic 960 and information 961. DFFD subband based basis PMI logic of examples may include various instructions, code, routines, procedures, etc. configured to perform operations and/or functions for facilitating and/or utilizing PMI for DFFD wireless signal communication according concepts described herein. Information 961 of examples may include various parameters, values, data, databases, information, etc. (e.g., CSI subband configuration information, RS configuration information, DFFD subband allocation information, CSI reports, DFFD subband based basis PMI, coefficients of spatial beams for DFFD wireless signal transmission, etc.) utilized by DFFD subband based basis PMI logic 960 and/or in association with operations and/or functions for facilitating and/or utilizing PMI for DFFD wireless signal communication.

Transmitter 956 is configured to transmit reference signals, synchronization signals, control information and data to one or more other devices, and receiver 958 is configured to receive reference signals, control information and data from one or more other devices. For example, transmitter 956 may transmit signaling, control information and data to, and receiver 958 may receive signaling, control information and data from, UE 115. In some implementations, transmitter 956 and receiver 958 may be integrated in one or more transceivers. Additionally or alternatively, transmitter 956 or receiver 958 may include or correspond to one or more components of base station 105 described with reference to FIG. 2.

In some implementations, wireless communications system 900 implements a 5G NR network. For example, wireless communications system 900 may include multiple 5G-capable UEs 115 and multiple 5G-capable base stations 105, such as UEs and base stations configured to operate in accordance with a 5G NR network protocol such as that defined by the 3GPP.

During operation of wireless communications system 900 according to the illustrated example, base station 105 may transmit configuration information to UE 115 for one or more aspects of DFFD wireless signal communication. For example, processor 952 executing logic of DFFD subband based basis PMI logic 960 may control transmitter 956 to initiate transmission of configuration signal 970. Correspondingly, UE 115 may receive configuration information from base station 105 for use with respect to DFFD wireless signal communication. For example, processor 902 executing logic of DFFD subband based basis PMI logic 905 may control receiver 918 to initiate reception of configuration signal 970. Configuration signal 970 may be provided using RRC signaling, according to some aspects of the disclosure.

Configuration signal 970 according to some examples may comprise various configuration information utilized with respect to DFFD wireless signal communication. For example, configuration signal 970 of some examples may include CSI subband configuration information (e.g., CSI-RS bitmap), full duplex configuration, full duplex downlink subband(s) allocation, full duplex uplink subband(s) allocation, guard band(s) configuration, etc., with respect to DFFD wireless signal communication to be established between base station 105 and UE 115.

Base station 105 of wireless communications system 900 of the illustrated example may transmit one or more RSs for use by UE 115 in determining CSI. For example, processor 952 executing logic of DFFD subband based basis PMI logic 960 may control transmitter 956 to initiate transmission of RS signal 971. Correspondingly, UE 115 may receive or otherwise detect one or more RSs for determining CSI. For example, processor 902 executing logic of DFFD subband based basis PMI logic 905 may control receiver 918 to initiate reception of RS signal 971.

RS signal 971 according to some examples may comprise one or more signals configured to facilitate CSI measurements in one or more frequency bands (e.g., measurement of receive aspects with respect to the RSs) for obtaining feedback, such as for implementing precoding, beamforming, resource assignment, etc. The RSs may, for example, comprise a plurality of CQI subbands, corresponding to CSI configuration information provided by configuration signal 970, for CSI measurement by one or more UEs 115.

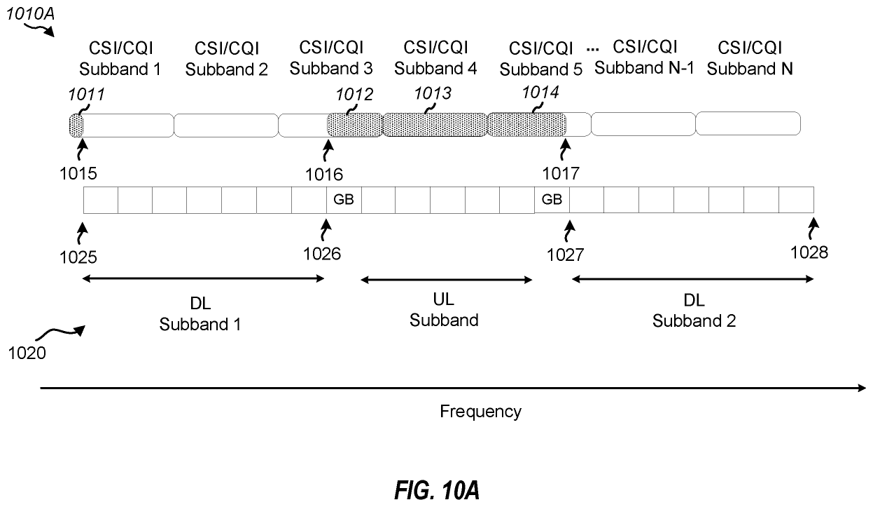

FIG. 10A illustrates example CSI subband configuration 1010A and DFFD subband allocation 1020 (e.g., providing a SBFD implementation) as may be utilized with respect to DFFD subband based basis PMI according to aspects of the disclosure. FIG. 10B illustrates example CSI subband configuration 1010B and DFFD subband allocation 1020 as may be utilized with respect to DFFD subband based basis PMI according to aspects of the disclosure.

The intersection of downlink BWP with downlink subbands according to an example is shown in FIG. 10A (i.e., the downlink subbands shown in FIG. 10A are not the whole downlink subband but are the intersection of the downlink subband with downlink BWP). As shown in the example illustrated in FIG. 10A, the CQI subbands (shown as CSI/CQI subband 1 through CSI/CQI subband N) may not align with the BWP boundaries (e.g., lower frequency boundary 1025 of downlink subband 1 and/or higher frequency boundary 1028 of downlink subband 2) of subbands allocated for DFFD wireless signal communication. This non-alignment with respect to the CSI subbands and outer DFFD BWP boundaries results in one or more CSI subbands fully or partially not overlapping (e.g., fully non-overlapping or partially non-overlapping in frequency) a DFFD downlink subband (e.g., CSI subband non-overlapping portion 1011 in which CSI/CQI subband 1 is non-overlapping with respect to the DFFD downlink subbands). Accordingly, there may be one or more outer edges (e.g., lower outer edge 1015 corresponding to the downlink subband 1 lower frequency boundary RB intersection with the CSI subbands of CSI subband configuration 1010A) at which a CQI subband does not fully overlap a downlink subband allocated for DFFD wireless signal communication. Although the example illustrated in FIG. 10A shows CSI subband non-overlapping portion 1011 and lower outer edge 1015 in association with the lower frequency DFFD BWP boundary, it should be appreciated that a CSI subband non-overlapping portion and upper outer edge may additionally or alternatively be present at the higher frequency DFFD BWP boundary in some examples of CSI subband configuration and DFFD subband allocation.

As described above, a DFFD wireless signal communication comprises a full duplex configuration having one or more downlink frequency band which is fully or partially non-overlapping the uplink frequency band(s) in the frequency domain. As shown in the example illustrated in FIG. 10A, the CQI subbands of a CSI subband configuration according to some aspects may not align with the DFFD downlink subband boundaries (e.g., upper frequency boundary 1026 of downlink subband 1 and/or lower frequency boundary 1027 of downlink subband 2) allocated for DFFD wireless signal communication. Accordingly, one or more CSI subbands may be fully or partially non-overlapping (e.g., fully non-overlapping or partially non-overlapping in frequency) with respect to a DFFD downlink subband and/or fully or partially overlapping with respect to a DFFD uplink subband (e.g., CSI subband non-overlapping portion 1012 in which CSI/CQI subband 3 is partially overlapping a guard band and the UL subband and is partially non-overlapping downlink subband 1, CSI subband non-overlapping portion 1013 in which CSI/CQI subband 4 is fully overlapping the UL subband and is fully non-overlapping the DFFD downlink subbands, and CSI subband non-overlapping portion 1014 in which CSI/CQI subband 5 is partially overlapping the UL subband and a guard band and is partially non-overlapping downlink subband 2). There may, therefore, be one or more inner edges (e.g., lower inner edge 1016 corresponding to the downlink subband 1 higher frequency boundary RB intersection with the CSI subbands of CSI subband configuration 1010A and upper inner edge 1017 corresponding to the downlink subband 2 lower frequency boundary RB intersection with the CSI subbands of CSI subband configuration 1010A) at which a CQI subband does not fully overlap a downlink subband allocated for DFFD wireless signal communication.

The intersection of downlink BWP with downlink subbands according to a further example is shown in FIG. 10B (i.e., the downlink subbands shown in FIG. 10B are not the whole downlink subband but are the intersection of the downlink subband with downlink BWP). As shown in the example illustrated in FIG. 10B, the CQI subbands (shown as CSI/CQI subband 1 through CSI/CQI subband N) may align with the outer BWP boundaries (e.g., lower frequency boundary 1025 of downlink subband 1 and/or higher frequency boundary 1028 of downlink subband 2) of subbands allocated for DFFD wireless signal communication. Even in a situation in which the CQI subbands align with the outer BWP boundaries of subbands allocated for DFFD wireless signal communication, the CQI subbands of a CSI subband configuration according to some aspects may not align with the inner BWP boundaries (e.g., upper frequency boundary 1026 of downlink subband 1 and/or lower frequency boundary 1027 of downlink subband 2) allocated for DFFD wireless signal communication. Accordingly, one or more CSI subbands may be fully or partially non-overlapping (e.g., fully non-overlapping or partially non-overlapping in frequency) with respect to a DFFD downlink subband and/or fully or partially overlapping with respect to a DFFD uplink subband (e.g., CSI subband non-overlapping portion 1012 in which CSI/CQI subband 3 is partially overlapping a guard band and the UL subband and is partially non-overlapping downlink subband 1, CSI subband non-overlapping portion 1013 in which CSI/CQI subband 4 is fully overlapping the UL subband and is fully non-overlapping the DFFD downlink subbands, and CSI subband non-overlapping portion 1014 in which CSI/CQI subband 5 is partially overlapping the UL subband and a guard band and is partially non-overlapping downlink subband 2). Thus, there may be one or more inner edges (e.g., lower inner edge 1016 corresponding to the downlink subband 1 higher frequency boundary RB intersection with the CSI subbands of CSI subband configuration 1010B and upper inner edge 1017 corresponding to the downlink subband 2 lower frequency boundary RB intersection with the CSI subbands of CSI subband configuration 1010B) at which a CQI subband does not fully overlap a downlink subband allocated for DFFD wireless signal communication.

The examples illustrated in FIGS. 10A and 10B show CSI subband non-overlapping portions 1012 and 1014 and lower inner edge 1016 and upper inner edge 1017. It should be appreciated, however, that a CSI subband non-overlapping portion and inner edge may be present at a single DFFD downlink subband boundary in some examples of CSI subband configuration and DFFD subband allocation (e.g., some DFFD configurations implementing IBFD).

During operation of wireless communications system 900 according to the illustrated example, UE 115 may transmit DFFD subband based basis PMI information to base station 105 for use with respect to DFFD wireless signal communication. For example, processor 902 executing logic of DFFD subband based basis PMI logic 905 may control transmitter 916 to initiate transmission of DFFD subband based basis PMI signal 980. Correspondingly, base station 105 may receive DFFD subband based basis PMI signal 980 for use with respect to implementing aspects of DFFD wireless signal communication. For example, processor 952 executing logic of DFFD subband based basis PMI logic 960 may control receiver 958 to initiate reception of DFFD subband based basis PMI signal 980.

DFFD subband based basis PMI included in DFFD subband based basis PMI signal 980 according to some examples may comprise a frequency domain compression of coefficients of spatial beams in a precoding matrix for DFFD downlink signal transmission in accordance with a frequency domain compression basis parameter determined based at least in part on a correspondence between downlink subbands for the DFFD downlink wireless signal and CSI subbands. For example, UE 115 may monitor RS signal 971, determine DFFD subband based basis PMI using a frequency domain compression basis parameter for frequency domain compression of coefficients of the spatial beams in the precoding matrix determined based at least in part on a correspondence between downlink subbands for the DFFD downlink wireless signal and CSI subbands of a CSI subband configuration, and transmit DFFD subband based basis PMI signal 980 comprising a compressed representation of the coefficients as a PMI.

During operation of wireless communications system 900 according to the illustrated example, UE 115 may transmit DFFD subband based basis PMI for use by base station 105 for use with respect to DFFD wireless signal communication. For example, processor 902 executing logic of DFFD subband based basis PMI logic 905 may control transmitter 916 to initiate transmission of DFFD subband based basis PMI signal 980. Correspondingly, base station 105 may receive DFFD subband based basis PMI for use with respect to DFFD wireless signal communication. For example, processor 952 executing logic of DFFD subband based basis PMI logic 960 may control receiver 958 to initiate reception of DFFD subband based basis PMI signal 980.

DFFD subband based basis PMI of aspects comprises a frequency domain compression of coefficients of spatial beams in a precoding matrix for DFFD downlink signal transmission. For example, DFFD subband based basis PMI signal 980 may include one or more CSI reports for DFFD wireless signal communication, wherein the CSI reports comprise DFFD subband based basis PMI provided using frequency domain compression based at least in part on a correspondence between downlink subbands for a DFFD wireless signal and CSI subbands of a CSI subband configuration.

In operation according to aspects of the disclosure, UE 115 of wireless communications system 900 may determine a frequency domain compression of coefficients of spatial beams in a precoding matrix for DFFD downlink signal transmission and transmit PMI comprising the frequency domain compression to base station 105. For example, processor 902 executing logic of DFFD subband based basis PMI logic 905 may determine the frequency domain compression for a DFFD subband based basis PMI in accordance with a frequency domain compression basis parameter determined based at least in part on a correspondence between downlink subbands for the DFFD downlink wireless signal and CSI subbands. DFFD subband based basis PMI logic 905 may, according to some examples, utilize one or more aspects of information 906 (e.g., CSI measurement information derived from RS signal 971, CSI subband configuration information provided by configuration signal 970, DFFD subband allocation information provided by configuration signal 970, etc.) in determining the frequency domain compression for DFFD subband based basis PMI, the DFFD subband based basis, and/or one or more parameters used therein.

As illustrated by flow 800 of FIG. 8, the procedure for implementing frequency domain compression in eType-II codebook selects M frequency domain basis (e.g., frequency domain compression basis) out of N3 basis (e.g., the number of CSI subbands). In operation according to aspects of the present disclosure, the determination of CSI/CQI subbands is adapted to affect eTypeII PMI calculation for optimized frequency domain compression of PMI for DFFD wireless signal communication. For example, the number of CSI subbands, N3, may be determined as a first precoding matrix subband parameter for a precoding matrix selected based, at least in part, on a correspondence between downlink subbands for DFFD wireless signal and CSI subbands of a CSI subband configuration for the DFFD wireless signal.

In accordance with a first example, the number of CSI subbands, N3, determined with respect to DFFD subband based basis PMI may depend on effective CSI reporting bandwidth. Effective CSI reporting bandwidth according to aspects depends on the configuration of downlink subbands (e.g., intersection of downlink subbands with CSI reporting bandwidth).

Effective CSI reporting bandwidth in the CSI subband configuration and DFFD subband allocation implementation of FIG. 10A is: the portion of CSI/CQI subband 1 overlapping downlink subband 1 (i.e., the portion of CSI/CQI subband 1 to the right of lower outer edge 1015 corresponding to lower frequency boundary 1025 of downlink subband 1 comprising the lower frequency boundary RB intersection with the CSI subbands); CSI/CQI subband 2 overlapping downlink subband 1; the portion of CSI/CQI subband 3 overlapping downlink subband 1 (i.e., the portion of CSI/CQI subband 3 to the left of lower inner edge 1016 corresponding to upper frequency boundary 1026 of downlink subband 1 comprising the higher frequency boundary RB intersection with the CSI subbands); the portion of CSI/CQI subband 5 overlapping downlink subband 2 (i.e., the portion of CSI/CQI subband 5 to the right of upper inner edge 1017 corresponding lower frequency boundary 1027 of downlink subband 2 comprising the lower frequency boundary RB intersection with the CSI subbands); the CSI/CQI subband N-1 overlapping downlink subband 2; and CSI/CQI subband N overlapping downlink subband 2.

Effective CSI reporting bandwidth in the CSI subband configuration and DFFD subband allocation implementation of FIG. 10B is: CSI/CQI subband 1 overlapping downlink subband 1; CSI/CQI subband 2 overlapping downlink subband 1; the portion of CSI/CQI subband 3 overlapping downlink subband 1 (i.e., the portion of CSI/CQI subband 3 to the left of lower inner edge 1016 corresponding to upper frequency boundary 1026 of downlink subband 1 comprising the higher frequency boundary RB intersection with the CSI subbands); the portion of CSI/CQI subband 5 overlapping downlink subband 2 (i.e., the portion of CSI/CQI subband 5 to the right of upper inner edge 1017 corresponding lower frequency boundary 1027 of downlink subband 2 comprising the lower frequency boundary RB intersection with the CSI subbands); the CSI/CQI subband N-1 overlapping downlink subband 2; and CSI/CQI subband N overlapping downlink subband 2.

In operation according to this first example, the number of CSI subbands, N3, may be computed based on CSI subband config for DFFD wireless signal communication, where a valid CSI subband for computing the number of CSI subbands has at least one RB with CSI-RS. According to some aspects, only fully overlapping CSI subbands may be taken into account for the number of CSI subbands, N3, (e.g., the number of CSI subbands may be computed based on the 3 fully overlapping CSI subbands in the example of FIG. 10A above and the number of CSI subbands may be computed based on the 4 fully overlapping CSI subbands in the example of FIG. 10B above). According to a further aspects, partially overlapping CSI subbands may be taken into account for the number of CSI subbands, N3, (e.g., the number of CSI subbands may be computed based on the 3 fully overlapping CSI subbands and the 3 partially overlapping CSI subbands in the example of FIG. 10A above and the number of CSI subbands may be computed based on the 4 fully overlapping CSI subbands and the 2 partially overlapping CSI subbands in the example of FIG. 10B above). Computing the number of CSI subbands based on CSI subbands having at least one RB with CSI-RS according to aspects of the disclosure facilitates efficient frequency domain compression (e.g., redundant computations are avoided in compression of the coefficients).

In accordance with a second example, the number of CSI subbands, N3, determined with respect to DFFD subband based basis PMI may be calculated separately for each downlink subband (e.g., N3_sb1, N3_sb2, etc.). According to aspects of this second example, in a situation having common CQI/RI (rank indicator) and spatial domain basis for the downlink subbands, separate sets of DFFD subband based basis PMI coefficients may be calculated for each downlink subband based at least in part on the number of CSI subbands determined for a respective downlink subband.

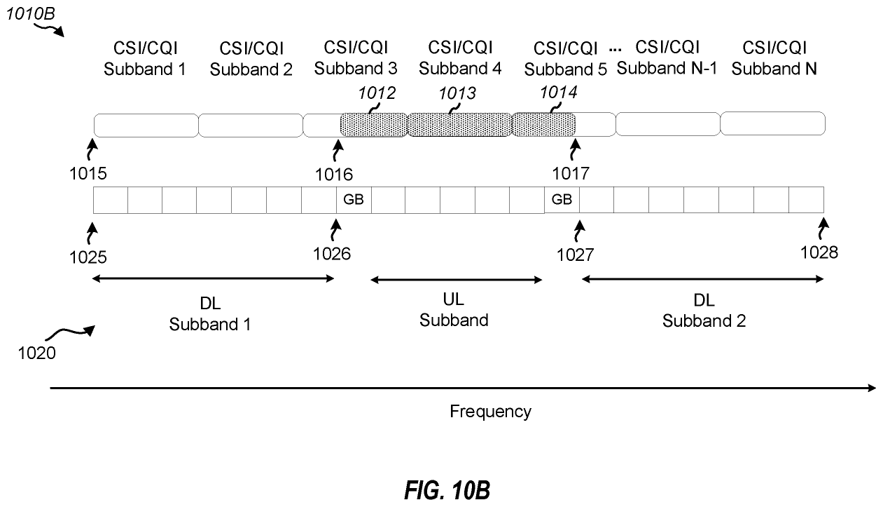

According to an aspect of this second example, M frequency domain basis is selected for the frequency domain compression basis with respect to a downlink subband out of a corresponding N3 basis (e.g., M out of N3_sb1 or N3_sb2. or N3_sbM for a respective one of downlink subband 1 or downlink subband 2. or downlink subband M). FIG. 11 illustrates an example in which M frequency domain basis is selected out of N3_sb1 or N3_sb2 (e.g., N3_sb1=4 and N3_sb2=3, wherein M_sb1 is selected out of 4 for the frequency domain basis for downlink subband 1 and M_sb2 is selected out of 3 for the frequency domain basis for downlink subband 1) for frequency domain compression of coefficients of spatial beams for each downlink subband. It should be appreciated that M_sb1 may be equal to M_sb2 or M_sb1 may be unequal to M_sb2 in various situations implemented according to the example of FIG. 11.

According to another aspect of this second example, M frequency domain basis is selected for the frequency domain compression basis out of one of a plurality of N3 basis (e.g., N3 =max(N3_sb1, N3_sb2, . . . N3_sbM)). In operation, a selected M frequency domain basis is used to calculate a plurality of sets of frequency domain compression of coefficients. For example, M frequency domain basis may be selected from N3=max(N3_sb1, N3_sb2) (e.g., (e.g., N3_sb1=4 and N3_sb2=3, wherein M is selected out of 4) and is used to calculate frequency domain compression of coefficients for each of downlink subband 1 and downlink subband 2. If N3_sb2<N3_sb1, then zero coefficients may be utilized for dummy PMI subbands (e.g., N3_sb1−N3_sb2 PMI subbands). However, computing the number of CSI subbands based on M frequency domain basis selected out of one of a plurality of N3 basis according to aspects of the disclosure facilitates simplified implementations for frequency domain compression (e.g., same DFT size can be used for a plurality of downlink subbands).

In accordance with aspects of the foregoing second example, frequency domain basis and corresponding DFFD subband based basis PMI coefficients may be calculated for each downlink subband separately. Operation according to concepts herein may provide for multiple sets of frequency domain basis and corresponding DFFD subband based basis PMI coefficients being included in one multi-downlink subband CSI report (e.g., a single report provided in DFFD subband based basis PMI signal 980 including frequency domain basis and corresponding DFFD subband based basis PMI coefficients for each downlink subband). For example, a new uplink control information (UCI) payload design and priority rules may be configured for facilitating the foregoing multi-downlink subband CSI report. Additionally or alternatively, operation may provide for each set of multiple sets of frequency domain basis and corresponding DFFD subband based basis PMI coefficients being included in a respective separate downlink subband CSI report (e.g., a separate report provided in DFFD subband based basis PMI signal 980 for each frequency domain basis and corresponding DFFD subband based basis PMI coefficients for each downlink subband). For example, one of the downlink subbands may be labeled as primary, another may be labeled as secondary, and so on. A first CSI report (e.g., primary report) may include the frequency domain basis and corresponding DFFD subband based basis PMI coefficients for the primary downlink subband, a second CSI report (e.g., secondary report) may include the frequency domain basis and corresponding DFFD subband based basis PMI coefficients for the secondary downlink subband, and so on. According to some aspects, the separate downlink subband CSI reports may be linked in RRC configuration (e.g., the primary report may be provided with a field to indicate linkage to one or more additional reports, such as the secondary report, etc.). Restrictions may be implemented with respect to RRC parameters of linked reports to make the linkage valid. Additionally or alternatively, CSI reporting configuration parameters (e.g., reportQuantity, codebook params, etc.) may be aligned with respect to the separate downlink subband CSI reports.

In accordance with a third example, the number of CSI subbands, N3, may be determined based on bitmap spanning all CSI reporting bandwidth. According to aspects, if a UE is configured to report CSI for CSI subbands fully overlapping with an uplink subband and/or guard band, the UE may report dummy CSI (e.g., DFFD subband based basis PMI coefficients are set to zeros). For example, a CSI configuration bitmap provided with respect to CSI subband configuration 1010A or 1010B (FIGS. 10A and 10B) may indicate CSI subbands=0111110, wherein CSI/CQI subband 2 through CSI/CQI subband N-1 comprise the CSI reporting bandwidth. CSI/CQI subband 4 of CSI subband configurations 1010A and 1010B fully overlaps the uplink subband. According to aspects of this third example, UE 115 may report dummy CSI with respect to CSI/CQI subband 4.

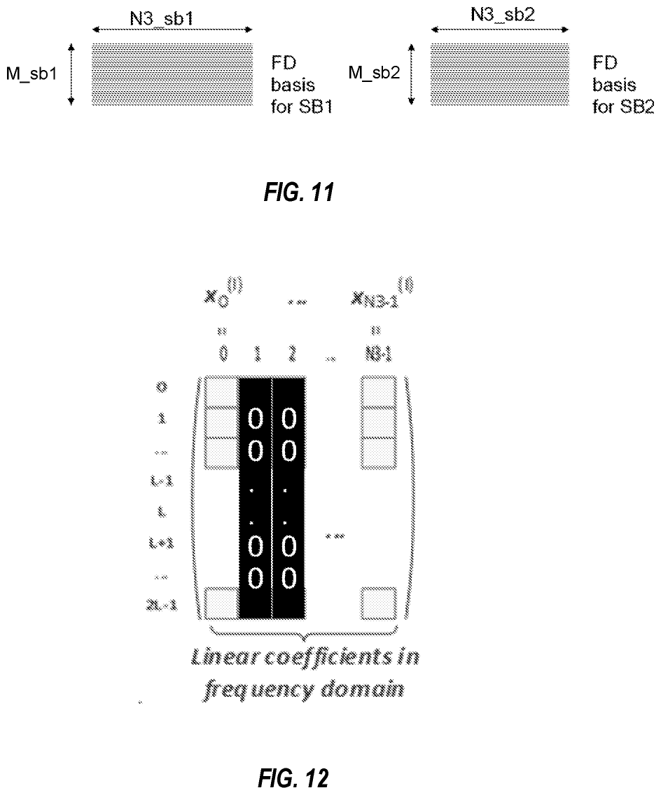

FIG. 12 shows an example of the coefficients on each PMI subband per layer having coefficients for PMI subbands 1 and 2, corresponding to one or more CSI subbands fully overlapping an uplink subband and/or guard band, set to zeros (i.e., dummy CSI). In particular, the matrix containing linear combination of beams for N3 subbands has “zero” columns corresponding to the subbands contained in an uplink subband and/or guard band. The use of such dummy CSI according to this third example may provide less efficient frequency domain compression (e.g., as compared to implementations according to the first and second examples above) due to redundant computations a in compression of the coefficients in association with the dummy CSI.

Operation in accordance with examples herein may support finer PMI granularity than that of the CSI/CQI subbands. In accordance with some aspects, PMI reporting granularity may be indicated as finer compared with CSI/CQI subbands through use of a PMI granularity parameter (e.g., number of PMI subbands per CQI subband parameter, R, such as may be provided in CSI configuration information). For example, if the number of PMI subbands per CQI parameter is a first value (e.g., R=1), PMI granularity may be that of the CSI/CQI subbands. However, if the number of PMI subbands per CQI parameter is a second value (e.g., R=2), PMI granularity may be finer than that of the CSI/CQI subbands according to aspects of the present disclosure.

According to some aspects, if the number of PMI subbands per CQI parameter is a value indicating finer PMI granularity (e.g., R=2), the number of PMIs to be reported may be determined based at least in part on analysis of edge CSI/CQI subbands and/or CSI/CQI subbands overlapping with one or more uplink subbands and/or guard bands.

In some examples, the number of PMIs reported for CSI/CQI subbands partially overlapping with an uplink subband and/or guard band (e.g., CSI/CQI subband 1, CSI/CQI subband 3, and CSI/CQI subband 5 of CSI subband configuration 1010A in FIG. 10A or CSI/CQI subband 3 and CSI/CQI subband 4 of CSI subband configuration 1010B in FIG. 10B) is dependent upon the number of RBs in the CSI/CQI subband (e.g., CSI/CQI subband RBs of the portion overlapping a downlink subband). As an example, if the number of RBs in the CSI/CQI subband is less than or equal to one half the number of RBs in the configured CSI/CQI subband size (e.g. #RBs <=nominal CQI subband size/2), the number of PMIs reported for this CSI/CQI subband may be 1 PMI. If, however, the number of RBs in the CSI/CQI subband is greater than one half the number of RBs in the CSI/CQI subband size (e.g., #RBs>nominal CQI subband size/2), the number of PMIs reported for this CSI/CQI subband may be 2 PMIs. Applying the above to the example of FIGS. 10A, 2 PMIs may be reported with respect CSI/CQI subband 1, and 1 PMI may be reported with respect to each of CSI/CQI subband 3 and CSI/CQI subband 5. Applying the above to the example of FIGS. 10B, 1 PMI may be reported with respect to each of CSI/CQI subband 3 and CSI/CQI subband 5. Further, according to these examples, 2 PMI may be reported for the CSI/CQI subbands fully overlapping downlink subbands (e.g., CSI/CQI subband 2, CSI/CQI subband N-1, and CSI/CQI subband N of FIG. 10A and CSI/CQI subband 1, CSI/CQI subband 2, CSI/CQI subband N-1, and CSI/CQI subband N of FIG. 10B).

In further examples, the number of PMIs reported for CSI/CQI subbands partially overlapping with an uplink subband and/or guard band (e.g., CSI/CQI subband 1, CSI/CQI subband 3, and CSI/CQI subband 5 of CSI subband configuration 1010A in FIG. 10A or CSI/CQI subband 3 and CSI/CQI subband 4 of CSI subband configuration 1010B in FIG. 10B) corresponds to the number of PMIs for finer PMI granularity. As an example, if a CSI/CQI subband is partially overlapping with an uplink subband and/or guard band, the number of PMIs reported for this CSI/CQI subband may be 2 PMI. Applying the above to the example of FIGS. 10A, 2 PMIs may be reported with respect each of CSI/CQI subband 1, CSI/CQI subband 3, and CSI/CQI subband 5. Applying the above to the example of FIGS. 10B, 2 PMIs may be reported with respect to each of CSI/CQI subband 3 and CSI/CQI subband 5. Further, according to these examples, 2 PMI may be reported for the CSI/CQI subbands fully overlapping downlink subbands (e.g., CSI/CQI subband 2, CSI/CQI subband N-1, and CSI/CQI subband N of FIG. 10A and CSI/CQI subband 1, CSI/CQI subband 2, CSI/CQI subband N-1, and CSI/CQI subband N of FIG. 10B).

In further examples, the number of PMIs reported for CSI/CQI subbands partially overlapping with an uplink subband and/or guard band (e.g., CSI/CQI subband 1, CSI/CQI subband 3, and CSI/CQI subband 5 of CSI subband configuration 1010A in FIG. 10A or CSI/CQI subband 3 and CSI/CQI subband 4 of CSI subband configuration 1010B in FIG. 10B) is determined in accordance with a PMI edge rule defined with respect to inner edge subbands. A PMI edge rule according to some aspects may provide one or more restriction with respect to the number of CSI/CQI subbands having edges (e.g., inner edge and/or outer edge) at which a CQI subband does not fully overlap a downlink subband that may be reported using 1 PMI and/or 2 PMIs. For example, a PMI edge rule may restrict a maximum of 2 edge (inner or outer) CSI/CQI subbands to 1 PMI (e.g., ordered by size of RB overlap with downlink subbands, such that edge CSI/CQI subbands having the least RB overlap report 1 PMI). As another example, a PMI edge rule may restrict a first type of edge CSI/CQI subband (inner or outer) to 1 PMI and a second type of edge CSI/CQI subband (outer or inner) to 2 PMIs.

UE 115 of wireless communications system 900 may determine a frequency domain compression of coefficients of spatial beams in a precoding matrix for DFFD downlink signal transmission in accordance with one or more of the foregoing examples for transmitting PMI comprising the frequency domain compression in DFFD subband based basis PMI signal 980. Base station 105 may thus receive DFFD subband based basis PMI signal 980 for use with respect to implementing aspects of DFFD wireless signal communication in accordance with aspects of the disclosure.

During operation of wireless communications system 900 according to the example illustrated in FIG. 9, base station 105 may utilize DFFD subband based basis PMI, received from UE 115 via DFFD subband based basis PMI signal 980, with respect to DFFD wireless signal communication. For example, processor 952 executing logic of DFFD subband based basis PMI logic 960 may analyze DFFD subband based basis PMI provided by UE 115 and one or more aspects of information 906 (e.g., one or more predefined matrices of coefficients for spatial beams, one or more formula defining precoding matrices of coefficients for spatial beams, etc.) to determine whether to initiate transmission of the DFFD wireless signal implementing the precoding matrix of the DFFD subband based basis PMI or another precoding matrix configuration. Thereafter, base station 105 may initiate transmission of DFFD downlink transmission to UE 115 via DFFD downlink signal 972 using a selected precoding matrix configuration (e.g., the DFFD subband based basis PMI or another precoding matrix configuration). For example, processor 952 executing logic of DFFD subband based basis PMI logic 960 may control transmitter 956 to initiate transmission of DFFD downlink signal 972. Correspondingly, UE 115 may receive DFFD downlink signal 972. For example, processor 902 executing logic of DFFD subband based basis PMI logic 905 may control receiver 918 to initiate reception of DFFD downlink signal 972.

As described with reference to FIG. 9, the present disclosure provides techniques for PMI having frequency domain compression optimized or otherwise configured for DFFD wireless signal communication. For example, DFFD subband based basis PMI provided according to concepts of the present disclosure may be utilized for optimized frequency domain compression of PMI for DFFD wireless signal communication facilitating reduced CSI overhead. Computation of a number of CSI subbands according to aspects of the disclosure facilitates efficient frequency domain compression (e.g., avoiding redundant computations in compression of the coefficients). Additionally or alternatively, computation of a number of CSI subbands according to aspects of the disclosure facilitates simplified implementations for frequency domain compression (e.g., same DFT size can be used for a plurality of downlink subbands).

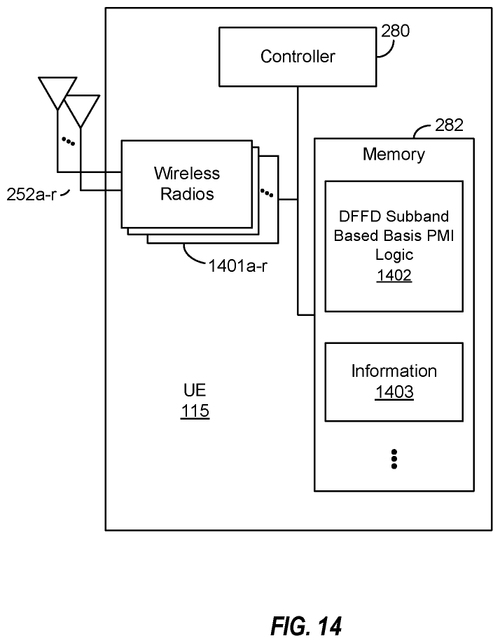

FIG. 13 is a flow diagram illustrating example process 1300 that supports DFFD subband based basis PMI comprising frequency domain compression based at least in part on a correspondence between downlink subbands for a DFFD wireless signal and CSI subbands of a CSI subband configuration for the DFFD wireless signal communication according to one or more aspects. Operations of process 1300 may be performed by a UE, such as UE 115 described above with reference to FIGS. 1, 2, 9, and/or a UE described below with reference to FIG. 14. For example, example operations (also referred to as “blocks”) of process 1300 may be performed by DFFD subband based basis PMI logic of UE 115 to enable the UE to support DFFD subband based basis PMI comprising frequency domain compression based at least in part on a correspondence between downlink subbands for a DFFD wireless signal and CSI subbands of a CSI subband configuration for the DFFD wireless signal communication.

In block 1301 of the illustrated example of process 1300, the UE may determine a first precoding matrix subband parameter for a precoding matrix selected by the UE to be used in communication of a DFFD wireless signal via one or more spatial beams. The first precoding matrix subband parameter may, for example, comprise the number of CSI subbands, N3, determined with respect to DFFD subband based basis PMI. In accordance with aspects of the disclosure, the first precoding matrix subband parameter may be determined based, at least in part, on a correspondence between one or more downlink subbands for the DFFD wireless signal and CSI subbands of a CSI subband configuration for the DFFD wireless signal.

According to aspects of the disclosure, DFFD subband based basis PMI logic executed by the UE may operate to determine the first precoding matrix subband parameter. In an example, the first precoding matrix subband parameter may be determined based, at least in part, on a number of the CSI subbands having a RB intersection with a downlink subband of the downlink subbands for the DFFD wireless signal communication. According to some examples, the UE may determine a second precoding matrix subband parameter for the precoding matrix selected by the UE to be used in communication of the DFFD wireless signal via the one or more spatial beams. For example, the second precoding matrix subband parameter may be determined based, at least in part, on correspondence between the downlink subbands for the DFFD wireless signal and the CSI subbands of the CSI subband configuration for the DFFD wireless signal. The first precoding matrix subband parameter may be determined for a first downlink subband of the downlink subbands and the second precoding matrix subband parameter may be determined for a second downlink subband of the downlink subbands.

According to some examples, the DFFD wireless signal may comprise a SBFD wireless signal. According to further examples, the DFFD wireless signal may comprise a IBFD wireless signal having one or more downlink frequency band which is at least partially non-overlapping the uplink frequency band(s) in the frequency domain.

In block 1302 of the illustrated example, the UE may determine a first frequency domain compression basis parameter for frequency domain compression of coefficients of the spatial beams in the precoding matrix. According to aspects of the disclosure, the first frequency domain compression basis parameter is determined based, at least in part, on the first precoding matrix subband parameter. The first frequency domain compression basis parameter may, for example, comprise M frequency domain basis selected out of the number of CSI subbands, N3, determined with respect to DFFD subband based basis PMI.

According to aspects of the disclosure, DFFD subband based basis PMI logic executed by the UE may operate to determine the first precoding matrix subband parameter. In an example, the UE may determine a second frequency domain compression basis parameter for frequency domain compression of coefficients of the spatial beams in the precoding matrix. For example, the second frequency domain compression basis parameter may be determined based, at least in part, on a second precoding matrix subband parameter. In accordance with aspects of the disclosure, the compressed representation of the coefficients may comprise a frequency domain compression of the coefficients in accordance with the first frequency domain compression basis parameter associated with the first downlink subband and a frequency domain compression of the coefficients in accordance with the second frequency domain compression basis parameter associated with the second downlink subband. In accordance with further aspects of the disclosure, the UE may select the first precoding matrix subband parameter for providing the compressed representation of the coefficients based upon a value of the first precoding matrix subband parameter being greater than a value of the second precoding matrix subband parameter. The compressed representation of the coefficients of some examples may comprise a frequency domain compression of the coefficients in accordance with the first frequency domain compression basis parameter associated with the first downlink subband and a frequency domain compression of the coefficients in accordance with the first frequency domain compression basis parameter associated with the second downlink subband.

In block 1303, the UE may transmission of a compressed representation of the coefficients as a PMI. The PMI may, for example, comprise DFFD subband based basis PMI having frequency domain compression optimized or otherwise configured for DFFD wireless signal communication. The compressed representation of the coefficients may, for example, comprise a frequency domain compression of the coefficients in accordance with the first frequency domain compression basis parameter.

According to aspects of the disclosure, DFFD subband based basis PMI logic executed by the UE may operate to determine the PMI (e.g., DFFD subband based basis PMI) using the first frequency domain compression basis parameter and/or the second frequency domain compression basis, and initiate transmission of PMI. In an example, the compressed representation of the coefficients may be transmitted as a PMI report, such as may include the compressed representation of the coefficients and a corresponding frequency domain compression basis parameter. According to aspects of the disclosure, a PMI report configured for DFFD wireless signal communication may include the first frequency domain compression basis parameter and a corresponding compressed representation of the coefficients, and the second frequency domain compression basis parameter and a corresponding compressed representation of the coefficients. According to further aspects of the disclosure, PMI reports configured for DFFD wireless signal communication may comprise a first PMI report including the first frequency domain compression basis parameter and a corresponding compressed representation of the coefficients, and a second PMI report including the second frequency domain compression basis parameter and a corresponding compressed representation of the coefficients.

FIG. 14 is a block diagram of an example UE 115 that supports DFFD subband based basis PMI comprising frequency domain compression based at least in part on a correspondence between downlink subbands for a DFFD wireless signal and CSI subbands of a CSI subband configuration for the DFFD wireless signal communication according to one or more aspects. UE 115 may be configured to perform operations, including the blocks of process 1300 described with reference to FIG. 13. In some implementations, UE 115 includes the structure, hardware, and components shown and described with reference to UE 115 of FIGS. 1, 2 and 9. For example, UE 115 includes controller 280, which operates to execute logic or computer instructions stored in memory 282, as well as controlling the components of UE 115 that provide the features and functionality of UE 115. UE 115, under control of controller 280, transmits and receives signals via wireless radios 1401a-r and antennas 252a-r. Wireless radios 1401a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include DFFD subband based basis PMI logic 1402 and information 1403. In some implementations, DFFD subband based basis PMI logic 1402 and information 1403 include logic and information and perform functions as described with reference to DFFD subband based basis PMI logic 905 and information 906 of FIG. 9. DFFD subband based basis PMI logic 1402 may be configured to perform operations and/or functions for providing PMI for DFFD wireless signal communication according to concepts of the present disclosure. For example, DFFD subband based basis PMI logic 1402 may be configured to initiate reception of configuration signals, initiate reception of RS signals, determine precoding matrix subband parameters, determine frequency domain compression basis parameters, determine frequency domain compression for DFFD subband based basis PMIs, initiate transmission of DFFD subband based basis PMI signals, etc. Information 1403 may be configured to store parameters, values, data, databases, information, etc. utilized by DFFD subband based basis PMI logic 1402 and/or in association with operations and/or functions for providing PMI for DFFD wireless signal communication. For example, information 1403 may store CSI measurement information, CSI subband configuration information, DFFD subband allocation information, coefficients of spatial beams for DFFD wireless signal transmission, parameters used in computing DFFD subband based basis PMI, DFFD subband based basis PMI, etc. UE 115 may receive signals from or transmit signals to one or more network entities, such as base station 105 of FIGS. 1-3 and 16.

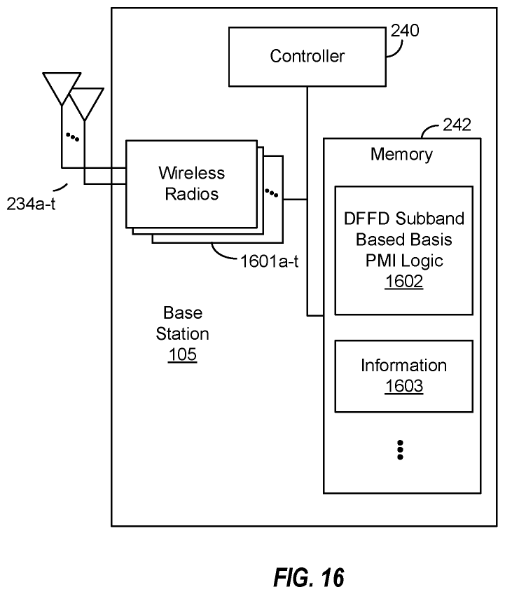

FIG. 15 is a flow diagram illustrating an example process 1500 that supports DFFD subband based basis PMI comprising frequency domain compression based at least in part on a correspondence between downlink subbands for a DFFD wireless signal and CSI subbands of a CSI subband configuration for the DFFD wireless signal communication according to one or more aspects. Operations of process 1500 may be performed by a base station, such as base station 105 described above with reference to FIGS. 1-3 and/or a base station as described below with reference to FIG. 16. For example, example operations of process 1500 may be performed by DFFD subband based basis PMI logic of base station 105 to enable the base station to support DFFD subband based basis PMI comprising frequency domain compression based at least in part on a correspondence between downlink subbands for a DFFD wireless signal and CSI subbands of a CSI subband configuration for the DFFD wireless signal communication.

At block 1501 of the illustrated example of process 1500, the base station may transmit a CSI subband configuration with respect to DFFD wireless signal communication. The CSI subband configuration may, for example, comprise various configuration information utilized with respect to DFFD wireless signal communication. In accordance with aspects of the disclosure, the CSI subband configuration may include CSI subband configuration information (e.g., CSI-RS bitmap), full duplex configuration, full duplex downlink subband(s) allocation, full duplex uplink subband(s) allocation, guard band(s) configuration, etc., with respect to DFFD wireless signal communication to be established between base station 105 and another wireless communication device.

According to aspects of the disclosure, DFFD subband based basis PMI logic executed by the base station may operate to determine or otherwise obtain (e.g., from information stored by the base station) a CSI subband configuration with respect to DFFD wireless signal communication to be established between base station 105 and one or more wireless communication devices. The DFFD subband based basis PMI logic may thereafter initiate transmission of the CSI subband configuration to the one or more wireless communication devices (e.g., UE 115).

According to some examples, the DFFD wireless signal may comprise a SBFD wireless signal. According to further examples, the DFFD wireless signal may comprise a IBFD wireless signal having one or more downlink frequency band which is at least partially non-overlapping the uplink frequency band(s) in the frequency domain.

In block 1502 of the illustrated example, the base station may receive a PMI comprising a compressed representation of coefficients of spatial beams of a precoding matrix configured for communication of the DFFD wireless signal via one or more spatial beams. The PMI may, for example, comprise DFFD subband based basis PMI having frequency domain compression optimized or otherwise configured for DFFD wireless signal communication. The compressed representation of the coefficients of examples may comprise a frequency domain compression of the coefficients in accordance with a first frequency domain compression basis parameter determined for the precoding matrix based, at least in part, on a first precoding matrix subband parameter. According to aspects of the disclosure, the first precoding matrix subband parameter is based, at least in part, on a correspondence between one or more downlink subbands for the DFFD wireless signal and CSI subbands of the CSI subband configuration.

According to aspects of the disclosure, DFFD subband based basis PMI logic executed by the base station may operate to initiate reception of a PMI comprising a compressed representation of coefficients of spatial beams of a precoding matrix configured for communication of the DFFD wireless signal via one or more spatial beams. In an example, the compressed representation of the coefficients may be received as a PMI report, such as may include the compressed representation of the coefficients and a corresponding frequency domain compression basis parameter. According to aspects of the disclosure, a PMI report configured for DFFD wireless signal communication may include the first frequency domain compression basis parameter and a corresponding compressed representation of the coefficients, and the second frequency domain compression basis parameter and a corresponding compressed representation of the coefficients. According to further aspects of the disclosure, PMI reports configured for DFFD wireless signal communication may comprise a first PMI report including the first frequency domain compression basis parameter and a corresponding compressed representation of the coefficients, and a second PMI report including the second frequency domain compression basis parameter and a corresponding compressed representation of the coefficients.

In block 1503, the base station may determine whether to initiate transmission of the DFFD wireless signal implementing the precoding matrix of the PMI or another precoding matrix configuration. For example, base station 105 may initiate transmission of DFFD downlink transmission to one or more wireless communication devices (e.g. UE 115) via one or more DFFD downlink signals using a selected precoding matrix configuration, as may be determined between the DFFD subband based basis PMI or one or more alternative precoding matrix configuration.

According to aspects of the disclosure, DFFD subband based basis PMI logic executed by the base station may operate to determine whether to initiate downlink DFFD wireless signal transmission using coefficients of spatial beams provided via DFFD subband based basis PMI received from one or more other wireless communication devices (e.g., UE 115) or using coefficients of spatial beams otherwise obtained (e.g., selected from predefined matrices stored by the base station, implementing a formula defining the precoding matrix, etc.). For example, coefficients of spatial beams provided via DFFD subband based basis PMI received from one or more other wireless communication devices may be analyzed with respect to coefficients of spatial beams otherwise obtained and/or one or more aspects of DFFD wireless signal communication (e.g., channel conditions, network congestion, wireless communication device locations and movement, resource allocations, etc.) for determine whether to initiate transmission of the DFFD wireless signal implementing the precoding matrix of the PMI or another precoding matrix configuration.

FIG. 16 is a block diagram of an example base station 105 that supports DFFD subband based basis PMI comprising frequency domain compression based at least in part on a correspondence between downlink subbands for a DFFD wireless signal and CSI subbands of a CSI subband configuration for the DFFD wireless signal communication according to one or more aspects. Base station 105 may be configured to perform operations, including the blocks of process 1500 described with reference to FIG. 15. In some implementations, base station 105 includes the structure, hardware, and components shown and described with reference to base station 105 of FIGS. 1-3 and 9. For example, base station 105 may include controller 240, which operates to execute logic or computer instructions stored in memory 242, as well as controlling the components of base station 105 that provide the features and functionality of base station 105. Base station 105, under control of controller 240, transmits and receives signals via wireless radios 1601a-t and antennas 234a-t. Wireless radios 1601a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include DFFD subband based basis PMI logic 1602 and information 1603. DFFD subband based basis PMI logic 1602 may be configured to perform operations and/or functions for facilitating and/or utilizing PMI for DFFD wireless signal communication according concepts described herein. For example, DFFD subband based basis PMI logic 1503 may be configured to initiate transmission of configuration information to one or more wireless communication devices (e.g., UE 115) for one or more aspects of DFFD wireless signal communication, initiate transmission of one or more RSs for use by the one or more wireless communication devices in determining CSI, initiate reception of DFFD subband based basis PMI signals for use with respect to implementing aspects of DFFD wireless signal communication, determine whether to initiate transmission of the DFFD wireless signal implementing the precoding matrix of the PMI or another precoding matrix configuration, and initiate transmission of DFFD downlink transmission to the one or more wireless communication devices via one or more DFFD downlink signals using selected precoding matrix configurations. Information 1603 may be configured to store parameters, values, data, databases, information, etc. utilized by DFFD subband based basis PMI logic 1602 and/or in association with operations and/or functions for providing PMI for DFFD wireless signal communication. For example, information 1603 may store CSI subband configuration information, RS configuration information, DFFD subband allocation information, CSI reports, DFFD subband based basis PMI, coefficients of spatial beams for DFFD wireless signal transmission, etc. Base station 16000 may receive signals from or transmit signals to one or more UEs, such as UE 115 of FIGS. 1, 2, and 14.

It is noted that one or more blocks (or operations) described with reference to FIGS. 13 and 15 may be combined with one or more blocks (or operations) described with reference to that figure or another of the figures. For example, one or more blocks (or operations) of FIG. 13 may be combined with one or more blocks (or operations) of FIG. 15. As another example, one or more blocks associated with FIG. 13 and/or FIG. 15 may be combined with one or more blocks (or operations) associated with FIGS. 1, 2, 3 and/or 9. Additionally, or alternatively, one or more operations described above with reference to FIGS. 1, 2, 3, and/or 9 may be combined with one or more operations described with reference to FIGS. 14 and/or 16.

In some examples of methods, the apparatuses, and articles including non-transitory computer-readable medium described herein, various aspects of DFFD subband based basis PMI may be implemented according to a multiplicity of combinations consistent with concepts described herein. Non-limiting examples of combinations of some aspects of a multi-slot transport block technique are set forth in the example clauses below.

1. Methods, apparatuses, and articles for wireless communication may provide for determining a first precoding matrix subband parameter for a precoding matrix selected by the UE to be used in communication of a DFFD wireless signal via one or more spatial beams, wherein the first precoding matrix subband parameter is determined based, at least in part, on a correspondence between one or more downlink subbands for the DFFD wireless signal and CSI subbands of a CSI subband configuration for the DFFD wireless signal, determining a first frequency domain compression basis parameter for frequency domain compression of coefficients of the spatial beams in the precoding matrix, wherein the first frequency domain compression basis parameter is determined based, at least in part, on the first precoding matrix subband parameter, and transmitting a compressed representation of the coefficients as a PMI, wherein the compressed representation of the coefficients comprises a frequency domain compression of the coefficients in accordance with the first frequency domain compression basis parameter.

2. The methods, apparatuses, and articles of clause 1, wherein the DFFD wireless signal is a SBFD wireless signal.

3. The methods, apparatuses, and articles of any of clauses 1 and 2, further providing for identifying RB intersections of the downlink subbands for the DFFD wireless signal communication and the CSI subbands of the CSI subband configuration, wherein the first precoding matrix subband parameter is determined based, at least in part, on a number of the CSI subbands having a RB intersection with a downlink subband of the downlink subbands for the DFFD wireless signal communication.

4. The methods, apparatuses, and articles of any of clauses 1-3, further providing for determining a second precoding matrix subband parameter for the precoding matrix selected by the UE to be used in communication of the DFFD wireless signal via the one or more spatial beams, wherein the second precoding matrix subband parameter is determined based, at least in part, on correspondence between the downlink subbands for the DFFD wireless signal and the CSI subbands of the CSI subband configuration for the DFFD wireless signal, and wherein the first precoding matrix subband parameter is determined for a first downlink subband of the downlink subbands and the second precoding matrix subband parameter is determined for a second downlink subband of the downlink subbands.

5. The methods, apparatuses, and articles of clause 4, further providing for determining a second frequency domain compression basis parameter for frequency domain compression of coefficients of the spatial beams in the precoding matrix, wherein the second frequency domain compression basis parameter is determined based, at least in part, on the second precoding matrix subband parameter, and wherein the compressed representation of the coefficients comprises a frequency domain compression of the coefficients in accordance with the first frequency domain compression basis parameter associated with the first downlink subband and a frequency domain compression of the coefficients in accordance with the second frequency domain compression basis parameter associated with the second downlink subband.

6. The methods, apparatuses, and articles of clause 5, further providing for transmitting the compressed representation of the coefficients as a PMI report including the first frequency domain compression basis parameter and a corresponding compressed representation of the coefficients and including the second frequency domain compression basis parameter and a corresponding compressed representation of the coefficients.

7. The methods, apparatuses, and articles of any of clauses 5 and 6, further providing for transmitting the compressed representation of the coefficients as a first PMI report including the first frequency domain compression basis parameter and a corresponding compressed representation of the coefficients and a second PMI report including the second frequency domain compression basis parameter and a corresponding compressed representation of the coefficients.

8. The methods, apparatuses, and articles of clause 4, further providing for selecting the first precoding matrix subband parameter for providing the compressed representation of the coefficients based upon a value of the first precoding matrix subband parameter being greater than a value of the second precoding matrix subband parameter, wherein the compressed representation of the coefficients comprises a frequency domain compression of the coefficients in accordance with the first frequency domain compression basis parameter associated with the first downlink subband and a frequency domain compression of the coefficients in accordance with the first frequency domain compression basis parameter associated with the second downlink subband.
9. The methods, apparatuses, and articles of clause 1, wherein the first precoding matrix subband parameter is based on each CSI subband of the CSI subband configuration, and wherein the coefficients comprise dummy entries corresponding to CS matrix subband parameter is determined based, at least in part, also on a PMI granularity parameter, wherein, when the PMI granularity parameter is a first value, individual CSI subbands of the CSI subband configuration that fully overlap a downlink subband of the downlink subbands are accounted for as one instance when determining the first precoding matrix subband parameter, and wherein, when the PMI granularity parameter is determined to be a second value, individual CSI subbands of the CSI subband configuration that fully overlap a downlink subband of the downlink subbands are accounted for as more than one instance when determining the first precoding matrix subband parameter.

11. The methods, apparatuses, and articles of clause 10, further providing for, when the PMI granularity parameter is determined to be the second value, identify CSI subbands of the CSI subband configuration having overlap of one or more RBs with an uplink subband or a guard band for the DFFD wireless signal communication as inner edge CSI subbands, wherein an inner edge CSI subband of the inner edge CSI subbands having a number of RBs that are overlapping RBs of a downlink subband of the downlink subbands less than or equal to one half a number of RBs of individual CSI subbands of the CSI subband configuration are accounted for as one instance when determining the first precoding matrix subband parameter, and wherein an inner edge CSI subband of the inner edge CSI subbands having a number of RBs that are overlapping RBs of a downlink subband of the downlink subbands greater than one half a number of RBs of individual CSI subbands of the CSI subband configuration are accounted for as two instances when determining the first precoding matrix subband parameter.

12. The methods, apparatuses, and articles of clause 10, wherein inner edge CSI subbands comprise CSI subbands of the CSI subband configuration having overlap of one or more RBs with an uplink subband or a guard band for the DFFD wireless signal communication, and wherein, when the PMI granularity parameter is determined to be the second value, the inner edge CSI subbands are accounted for as two instances in the first precoding matrix subband parameter.

13. The methods, apparatuses, and articles of clause 10, wherein inner edge CSI subbands comprise CSI subbands of the CSI subband configuration having overlap of one or more resource blocks (RBs) with an uplink subband or a guard band for the DFFD wireless signal communication, and wherein a number of instances with respect to inner edge CSI subbands accounted for when determining the first precoding matrix subband parameter is determined by a rule defined for addressing inner edge CSI subbands in determining the first precoding matrix subband parameter.

14. Methods, apparatuses, and articles for wireless communication may provide for transmitting a CSI subband configuration with respect to DFFD wireless signal communication, receiving a PMI comprising a compressed representation of coefficients of spatial beams of a precoding matrix configured for communication of the DFFD wireless signal via one or more spatial beams, wherein the compressed representation of the coefficients comprises a frequency domain compression of the coefficients in accordance with a first frequency domain compression basis parameter determined for the precoding matrix based, at least in part, on a first precoding matrix subband parameter, wherein the first precoding matrix subband parameter is based, at least in part, on a correspondence between one or more downlink subbands for the DFFD wireless signal and CSI subbands of the CSI subband configuration, and determining whether to initiate transmission of the DFFD wireless signal implementing the precoding matrix of the PMI or another precoding matrix configuration.

15. The methods, apparatuses, and articles of clause 14, wherein the DFFD wireless signal is a SBFD wireless signal.

16. The methods, apparatuses, and articles of any of clauses 14 and 15, wherein the first precoding matrix subband parameter is determined based, at least in part, on a number of the CSI subbands having a resource block (RB) intersection with a downlink subband of the downlink subbands for the DFFD wireless signal communication.

17. The methods, apparatuses, and articles of any of clauses 14-16, wherein the compressed representation of the coefficients comprises a frequency domain compression of the coefficients in accordance with the first frequency domain compression basis parameter associated with a first downlink subband of the downlink subbands and a frequency domain compression of the coefficients in accordance with a second frequency domain compression basis parameter associated with a second downlink subband of the downlink subbands, wherein the second frequency domain compression basis parameter is determined based, at least in part, on a second precoding matrix subband parameter, and wherein the second precoding matrix subband parameter is determined, at least in part, on correspondence between the downlink subbands for the DFFD wireless signal and the CSI subbands of the CSI subband configuration.

18. The methods, apparatuses, and articles of clause 17, wherein the compressed representation of the coefficients comprises a PMI report including the first frequency domain compression basis parameter and a corresponding compressed representation of the coefficients and including the second frequency domain compression basis parameter and a corresponding compressed representation of the coefficients.

19. The methods, apparatuses, and articles of any of clauses 17 and 18, wherein the compressed representation of the coefficients comprises a first PMI report including the first frequency domain compression basis parameter and a corresponding compressed representation of the coefficients and a second PMI report including the second frequency domain compression basis parameter and a corresponding compressed representation of the coefficients.

20. The methods, apparatuses, and articles of clause 14, wherein the compressed representation of the coefficients comprises a frequency domain compression of the coefficients in accordance with the first frequency domain compression basis parameter associated with a first downlink subband of the downlink subbands and a frequency domain compression of the coefficients in accordance with the first frequency domain compression basis parameter associated with a second downlink subband of the downlink subbands.

21. The methods, apparatuses, and articles of clause 14, wherein the first precoding matrix subband parameter is based on each CSI subband of the CSI subband configuration, and wherein the coefficients comprise dummy entries corresponding to CSI subbands that fully overlap an uplink subband or a guard band for the DFFD wireless signal communication.

22. The methods, apparatuses, and articles of any of clauses 14-21, wherein the first precoding matrix subband parameter is determined based, at least in part, also on a PMI granularity parameter, wherein, when the PMI granularity parameter is a first value, individual CSI subbands of the CSI subband configuration that fully overlap a downlink subband of the downlink subbands are accounted for as one instance when determining the first precoding matrix subband parameter, and wherein, when the PMI granularity parameter is determined to be a second value, individual CSI subbands of the CSI subband configuration that fully overlap a downlink subband of the downlink subbands are accounted for as more than one instance when determining the first precoding matrix subband parameter.

23. The methods, apparatuses, and articles of clause 22, wherein inner edge CSI subbands comprise CSI subbands of the CSI subband configuration having overlap of one or more resource blocks (RBs) with an uplink subband or a guard band for the DFFD wireless signal communication, wherein, when the PMI granularity parameter is determined to be the second value, an inner edge CSI subband of the inner edge CSI subbands having a number of RBs that are overlapping RBs of a downlink subband of the downlink subbands less than or equal to one half a number of RBs of individual CSI subbands of the CSI subband configuration are accounted for as one instance when determining the first precoding matrix subband parameter, and wherein, when the PMI granularity parameter is determined to be the second value, an inner edge CSI subband of the inner edge CSI subbands having a number of RBs that are overlapping RBs of a downlink subband of the downlink subbands greater than one half a number of RBs of individual CSI subbands of the CSI subband configuration are accounted for as two instances when determining the first precoding matrix subband parameter.

24. The methods, apparatuses, and articles of clause 22, wherein inner edge CSI subbands comprise CSI subbands of the CSI subband configuration having overlap of one or more resource blocks (RBs) with an uplink subband or a guard band for the DFFD wireless signal communication, and wherein, when the PMI granularity parameter is determined to be the second value, the inner edge CSI subbands are accounted for as two instances in the first precoding matrix subband parameter.

25. The methods, apparatuses, and articles of clause 22, wherein inner edge CSI subbands comprise CSI subbands of the CSI subband configuration having overlap of one or more resource blocks (RBs) with an uplink subband or a guard band for the DFFD wireless signal communication, and wherein a number of instances with respect to inner edge CSI subbands accounted for when determining the first precoding matrix subband parameter is determined by a rule defined for addressing inner edge CSI subbands in determining the first precoding matrix subband parameter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-3, 9, 14, and 16 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A user equipment (UE) comprising:
a memory storing processor-readable code; and
at least one processor coupled to the memory, the at least one processor configured to execute the processor-readable code to cause the at least one processor to:
determine a first precoding matrix subband parameter for a precoding matrix selected by the UE to be used in communication of a distinct frequency full duplex (DFFD) wireless signal via one or more spatial beams, wherein the first precoding matrix subband parameter is determined based, at least in part, on a correspondence between one or more downlink subbands for the DFFD wireless signal and channel state information (CSI) subbands of a CSI subband configuration for the DFFD wireless signal; determine a first frequency domain compression basis parameter for frequency domain compression of coefficients of the spatial beams in the precoding matrix, wherein the first frequency domain compression basis parameter is determined based, at least in part, on the first precoding matrix subband parameter; and
initiate transmission of a compressed representation of the coefficients as a precoding matrix indicator (PMI), wherein the compressed representation of the coefficients comprises a frequency domain compression of the coefficients in accordance with the first frequency domain compression basis parameter.

2. The UE of claim 1, wherein the DFFD wireless signal is a subband full duplex (SBFD) wireless signal.

3. The UE of claim 1, wherein the at least one processor is configured to execute the processor-readable code to cause the at least one processor to:
identify resource block (RB) intersections of the downlink subbands for the DFFD wireless signal communication and the CSI subbands of the CSI subband configuration, wherein the first precoding matrix subband parameter is determined based, at least in part, on a number of the CSI subbands having a RB intersection with a downlink subband of the downlink subbands for the DFFD wireless signal communication.

4. The UE of claim 1, wherein the at least one processor is configured to execute the processor-readable code to cause the at least one processor to:
determine a second precoding matrix subband parameter for the precoding matrix selected by the UE to be used in communication of the DFFD wireless signal via the one or more spatial beams, wherein the second precoding matrix subband parameter is determined based, at least in part, on correspondence between the downlink subbands for the DFFD wireless signal and the CSI subbands of the CSI subband configuration for the DFFD wireless signal, and wherein the first precoding matrix subband parameter is determined for a first downlink subband of the downlink subbands and the second precoding matrix subband parameter is determined for a second downlink subband of the downlink subbands.

5. The UE of claim 4, wherein the at least one processor is configured to execute the processor-readable code to cause the at least one processor to:
determine a second frequency domain compression basis parameter for frequency domain compression of coefficients of the spatial beams in the precoding matrix, wherein the second frequency domain compression basis parameter is determined based, at least in part, on the second precoding matrix subband parameter, and wherein the compressed representation of the coefficients comprises a frequency domain compression of the coefficients in accordance with the first frequency domain compression basis parameter associated with the first downlink subband and a frequency domain compression of the coefficients in accordance with the second frequency domain compression basis parameter associated with the second downlink subband.

6. The UE of claim 5, wherein the at least one processor is configured to execute the processor-readable code to cause the at least one processor to:
initiate transmission of the compressed representation of the coefficients as a PMI report including the first frequency domain compression basis parameter and a corresponding compressed representation of the coefficients and including the second frequency domain compression basis parameter and a corresponding compressed representation of the coefficients.

7. The UE of claim 5, wherein the at least one processor is configured to execute the processor-readable code to cause the at least one processor to:
initiate transmission of the compressed representation of the coefficients as a first PMI report including the first frequency domain compression basis parameter and a corresponding compressed representation of the coefficients and a second PMI report including the second frequency domain compression basis parameter and a corresponding compressed representation of the coefficients.

8. The UE of claim 4, wherein the at least one processor is configured to execute the processor-readable code to cause the at least one processor to:
select the first precoding matrix subband parameter for providing the compressed representation of the coefficients based upon a value of the first precoding matrix subband parameter being greater than a value of the second precoding matrix subband parameter, wherein the compressed representation of the coefficients comprises a frequency domain compression of the coefficients in accordance with the first frequency domain compression basis parameter associated with the first downlink subband and a frequency domain compression of the coefficients in accordance with the first frequency domain compression basis parameter associated with the second downlink subband.

9. The UE of claim 1, wherein the first precoding matrix subband parameter is based on each CSI subband of the CSI subband configuration, and wherein the coefficients comprise dummy entries corresponding to CSI subbands that fully overlap an uplink subband or a guard band for the DFFD wireless signal communication.

10. The UE of claim 1, wherein the first precoding matrix subband parameter is determined based, at least in part, also on a PMI granularity parameter, wherein, when the PMI granularity parameter is a first value, individual CSI subbands of the CSI subband configuration that fully overlap a downlink subband of the downlink subbands are accounted for as one instance when determining the first precoding matrix subband parameter, and wherein, when the PMI granularity parameter is determined to be a second value, individual CSI subbands of the CSI subband configuration that fully overlap a downlink subband of the downlink subbands are accounted for as more than one instance when determining the first precoding matrix subband parameter.

11. The UE of claim 10, wherein the at least one processor is configured to execute the processor-readable code to cause the at least one processor to:
when the PMI granularity parameter is determined to be the second value, identify CSI subbands of the CSI subband configuration having overlap of one or more resource blocks (RBs) with an uplink subband or a guard band for the DFFD wireless signal communication as inner edge CSI subbands, wherein an inner edge CSI subband of the inner edge CSI subbands having a number of RBs that are overlapping RBs of a downlink subband of the downlink subbands less than or equal to one half a number of RBs of individual CSI subbands of the CSI subband configuration are accounted for as one instance when determining the first precoding matrix subband parameter, and wherein an inner edge CSI subband of the inner edge CSI subbands having a number of RBs that are overlapping RBs of a downlink subband of the downlink subbands greater than one half a number of RBs of individual C SI subbands of the CSI subband configuration are accounted for as two instances when determining the first precoding matrix subband parameter.

12. The UE of claim 10, wherein inner edge CSI subbands comprise CSI subbands of the CSI subband configuration having overlap of one or more resource blocks (RBs) with an uplink subband or a guard band for the DFFD wireless signal communication, and wherein, when the PMI granularity parameter is determined to be the second value, the inner edge CSI subbands are accounted for as two instances in the first precoding matrix subband parameter.

13. The UE of claim 10, wherein inner edge CSI subbands comprise CSI subbands of the CSI subband configuration having overlap of one or more resource blocks (RBs) with an uplink subband or a guard band for the DFFD wireless signal communication, and wherein a number of instances with respect to inner edge CSI subbands accounted for when determining the first precoding matrix subband parameter is determined by a rule defined for addressing inner edge CSI subbands in determining the first precoding matrix subband parameter.

14. A network entity comprising:
a memory storing processor-readable code; and
at least one processor coupled to the memory, the at least one processor configured to execute the processor-readable code to cause the at least one processor to:
initiate transmission of a channel state information (CSI) subband configuration with respect to distinct frequency full duplex (DFFD) wireless signal communication;
initiate reception of a precoding matrix indicator (PMI) comprising a compressed representation of coefficients of spatial beams of a precoding matrix configured for communication of the DFFD wireless signal via one or more spatial beams, wherein the compressed representation of the coefficients comprises a frequency domain compression of the coefficients in accordance with a first frequency domain compression basis parameter determined for the precoding matrix based, at least in part, on a first precoding matrix subband parameter, wherein the first precoding matrix subband parameter is based, at least in part, on a correspondence between one or more downlink subbands for the DFFD wireless signal and CSI subbands of the CSI subband configuration; and
determine whether to initiate transmission of the DFFD wireless signal implementing the precoding matrix of the PMI or another precoding matrix configuration.

15. The network entity of claim 14, wherein the first precoding matrix subband parameter is determined based, at least in part, on a number of the CSI subbands having a resource block (RB) intersection with a downlink subband of the downlink subbands for the DFFD wireless signal communication.

16. The network entity of claim 14, wherein the compressed representation of the coefficients comprises a frequency domain compression of the coefficients in accordance with the first frequency domain compression basis parameter associated with a first downlink subband of the downlink subbands and a frequency domain compression of the coefficients in accordance with a second frequency domain compression basis parameter associated with a second downlink subband of the downlink subbands, wherein the second frequency domain compression basis parameter is determined based, at least in part, on a second precoding matrix subband parameter, and wherein the second precoding matrix subband parameter is determined, at least in part, on correspondence between the downlink subbands for the DFFD wireless signal and the CSI subbands of the CSI subband configuration.

17. The network entity of claim 16, wherein the compressed representation of the coefficients comprises a PMI report including the first frequency domain compression basis parameter and a corresponding compressed representation of the coefficients and including the second frequency domain compression basis parameter and a corresponding compressed representation of the coefficients.

18. The network entity of claim 16, wherein the compressed representation of the coefficients comprises a first PMI report including the first frequency domain compression basis parameter and a corresponding compressed representation of the coefficients and a second PMI report including the second frequency domain compression basis parameter and a corresponding compressed representation of the coefficients.

19. The network entity of claim 14, wherein the compressed representation of the coefficients comprises a frequency domain compression of the coefficients in accordance with the first frequency domain compression basis parameter associated with a first downlink subband of the downlink subbands and a frequency domain compression of the coefficients in accordance with the first frequency domain compression basis parameter associated with a second downlink subband of the downlink subbands.

20-24. (canceled)

25. A method of wireless communication performed by a user equipment (UE), the method comprising:
determining a first precoding matrix subband parameter for a precoding matrix selected by the UE to be used in communication of a distinct frequency full duplex (DFFD) wireless signal via one or more spatial beams, wherein the first precoding matrix subband parameter is determined based, at least in part, on a correspondence between one or more downlink subbands for the DFFD wireless signal and channel state information (CSI) subbands of a CSI subband configuration for the DFFD wireless signal;
determining a first frequency domain compression basis parameter for frequency domain compression of coefficients of the spatial beams in the precoding matrix, wherein the first frequency domain compression basis parameter is determined based, at least in part, on the first precoding matrix subband parameter; and
transmitting a compressed representation of the coefficients as a precoding matrix indicator (PMI), wherein the compressed representation of the coefficients comprises a frequency domain compression of the coefficients in accordance with the first frequency domain compression basis parameter.

26-30. (canceled)
